(19) United States
(12) Patent Application Publication
(10) Pub. No.: US 2023/0025403 A1
(43) Pub. Date: Jan. 26, 2023

(54) AN ARTICLE FOR USE IN AN AEROSOL PROVISION SYSTEM AND AN ARTICLE FOR USE IN A NON-COMBUSTIBLE AEROSOL PROVISION SYSTEM

(71) Applicant: Nicoventures Trading Limited, London (GB)

(72) Inventor: Andrei GRISHCHENKO, London (GB)

(21) Appl. No.: 17/785,253

(22) PCT Filed: Dec. 21, 2020
(86) PCT No.: PCT/GB2020/053338

§ 371 Date: Jun. 14, 2022

(30) Foreign Application Priority Data
Dec. 20, 2019 (GB) 1919107.1
Jun. 11, 2020 (GB) 2008906.6

(51) Int. Cl. A24D 1/20; A24D 3/17; A24D 1/04; A24D 3/10; A24D 3/06; A24D 3/04; A24B 15/12; A24D 1/02; A24F 40/20; D21H 27/02

(52) U.S. Cl. CPC A24D 1/20; A24D 3/17; A24D 1/04; A24D 3/10; A24D 3/061; A24D 3/048; A24B 15/12; A24D 3/043; A24D 1/02; A24F 40/20; D21H 27/02

(57) ABSTRACT

The present disclosure relates to an article (1) for use in a non-combustible aerosol provision system, the article comprising: an aerosol generating material (3), and a downstream portion (6) located downstream of the aerosol generating material, wherein the downstream portion comprises a body of material having a volume of at least 115 mm3 and wherein said body of material comprises cellulose. The present disclosure also relates to an article for use in aerosol provision system, the article comprising: an aerosol generating material, and a downstream portion located downstream of the aerosol generating material, wherein the downstream portion N comprises a body of material and a tubular element (20) located within the body of material, the tubular element comprising a cavity. The present disclosure also relates to an article for use in aerosol provision system, the article comprising: an aerosol generating material, and a downstream portion located downstream of the aerosol generating material, wherein the downstream portion comprises a body of material comprising cellulose, and wherein the downstream portion further comprises at least one aerosol modifying agent release component incorporated within the body of material.

### TECHNICAL FIELD

The present disclosure relates to an article for use in an aerosol provision system. The present disclosure also relates to an article for use in a non-combustible aerosol provision system.

### BACKGROUND

Certain tobacco industry products produce an aerosol during use, which is inhaled by a user. For example, tobacco heating devices heat an aerosol generating substrate such as tobacco to form an aerosol by heating, but not burning, the substrate. Such tobacco industry products commonly include mouthpieces through which the aerosol passes to reach the user's mouth.

### SUMMARY

According to the present disclosure, there is provided an article for use in a non-combustible aerosol provision system, the article comprising: an aerosol generating material, and a downstream portion located downstream of the aerosol generating material, wherein the downstream portion comprises a body of material having a volume of at least 115 mm³ and wherein said body of material comprises cellulose.

According to another aspect of the present disclosure, there is provided an article for use in aerosol provision system, the article comprising: an aerosol generating material, and a downstream portion located downstream of the aerosol generating material, wherein the downstream portion comprises a body of material and a tubular element located within the body of material, the tubular element comprising a cavity.

In some embodiments, the tubular element is located substantially radially centrally within the body of material.

In some embodiments, the tubular element extends to a downstream end of the body of material.

In some embodiments, the tubular element in manufactured from paper.

In some embodiments, the tubular element has a length of at least 4 mm and, preferably, a length of about 5 mm.

In some embodiments, the body of material has a volume of at least 115 mm³.

In some embodiments, the body of material comprises cellulose.

According to the present disclosure, there is also provided an article for use in aerosol provision system, the article comprising: an aerosol generating material, and a downstream portion located downstream of the aerosol generating material, wherein the downstream portion comprises a body of material comprising cellulose, and wherein the downstream portion further comprises at least one aerosol modifying agent release component incorporated within the body of material.

In some embodiments, the body of material has a volume of at least 115 mm3 and wherein said body of material comprises cellulose.

In some embodiments, the aerosol modifying agent release component comprises a capsule.

In some embodiments, the capsule comprises a solid shell and a liquid core.

In some embodiments, each capsule has a burst strength in the range 5 to 30 N.

In some embodiments, the aerosol modifying agent release component has a diameter in the range of 2.8 mm and 4 mm and, preferably, in the range of 2.8 mm and 3.6 mm.

In some embodiments, the body of material comprises a sheet of material arranged to form the body.

In some embodiments, the sheet material has a width of at least 60 mm and, preferably, at least 70, 80, 90, 100, 110 or 120 mm. That is, the body is formed from a sheet material having such a width.

In some embodiments, the sheet material has a width of at most 240 mm and, preferably, at most 230, 220, 210, 200, 190, 180, 170, 160 or 150 mm. That is, the body is formed from a sheet material having such a width.

In some embodiments, the sheet material has a width in the range of 60 to 240 mm and, preferably, in the range of 80 to 240 mm, in the range of 90 to 200 mm, or in the range of 100 to 170 mm.

In some embodiments, the sheet material has a basis weight of 100 gsm or less and, preferably, 90 gsm or less, 80 gsm or less, 70 gsm or less, 60 gsm or less, 50 gsm or less, or 40 gsm or less, or 30 gsm or less. In some embodiments, the basis weight of the sheet material is 20 gsm or less.

In some embodiments, the sheet material has a basis weight of at least 20 gsm and, preferably, at least 30, 40, 50 or 60 gsm.

In some embodiments, the sheet material has a basis weight in the range of 20 to 100 gsm and, preferably in the range of 25 to 80 gsm or in the range of 30 to 65 gsm.

In some embodiments, the body of material has a volume of least 200 mm³ or at least 300 mm³.

In some embodiments, the body of material has a volume of at least 19 mm³ per mm axial length of the body of material and, preferably, at least 25 mm³ per mm axial length or at least 30 mm³ per mm.

In some embodiments, the body of material has a weight of at least 2 mg per mm axial length of the body of material and, preferably, at least 3 mg per mm axial length or at least 4 mg per mm axial length.

In some embodiments, the body of material is a solid cylindrical body of material.

In some embodiments, the body of material comprises a sheet of material arranged to form the body.

In some embodiments, the sheet material has a basis weight of at least 15 gsm and, preferably, at least 20 gsm, at least 25 gsm, at least 30 gsm or at least 35 gsm.

In some embodiments, the sheet material has a basis weight of 80 gsm or less and preferably, of 60 gsm or less, 50 gsm or less, or 40 gsm or less.

In some embodiments, the sheet material is folded to form the body.

In some embodiments, the sheet material is crimped.

In some embodiments, the sheet material is crimped to a crimp depth of at least 0.2 mm and, preferably, at least 0.3 mm, 0.4 mm or 0.5 mm.

In some embodiments, the sheet material is crimped to a crimp depth of at most 0.8 mm and, preferably, at most 0.6 mm, or 0.5 mm.

In some embodiments, the body of material comprises paper.

In some embodiments, the body of material comprises reconstituted tobacco comprising the cellulose.

In some embodiments, the body has a density of at least 0.05 mg/mm³ and, preferably, density of at least 0.07 mg/mm³, or at least 0.1 mg/mm³, and, preferably, at least 0.12 mg/mm³.

In some embodiments, the pressure drop across the body of material is at least 2 mmWG and, preferably, at least 3 mmWG and, preferably, at least 4 mmWG, at least 6 mmWG, at least 8 mmWG, at least 10 mmWG or at least 11 mmWG, or at least 12 mmWG, or at least 15 mmWG, or at least 20 mmWG or at least 23 mmWG.

In some embodiments, the pressure drop across the body of material is less than 25 mmWG and, preferably, less than 23 mmWG, less than 20 mmWG, less than 15 mmWG, less than 14 mmWG and, preferably, less than 12 mmWG or less than 10 mmWG.

In some embodiments, the pressure drop across the body of material is in the range of to 25 mmWG and, preferably, is in the range of 12 to 23 mmWG or 13 to 20 mmWG.

In some embodiments, the pressure drop across the body of material is at least 0.2 mmWG per mm axial length of the body of material and, preferably, at least 0.3, 0.4, 0.6, or 0.8 mmWG per mm axial length of the body of material and, preferably, is at least 1, 1.1, 1.2, 1.5, 2 or 2.33 mmWG per mm axil length of the body of material.

In some embodiments, the pressure drop across the body of material is less than 2.5 mmWG per mm axial length of the body of material and, preferably, is less than 2.3, 2, 1.5, 1.4, 1.2 or 1 mmWG per mm axial length of the body of material.

In some embodiments, the pressure drop across the body of material is in the range of 1 to 2.5 mmWG per mm axial length of the body of material and, preferably, is in the range of 1.2 to 2.3 or 1.3 to 2 mmWG per mm axial length of the body of material.

In some embodiments, the body of material has an axial length of at least 4 mm and, preferably, at least 5 mm and, preferably, at least 6 mm, at least 7 mm, at least 8 mm, at least 9 mm or at least 10 mm.

In some embodiments, the body of material has an axial length of about 10 mm.

In some embodiments, the body of material has a circumference of at least 16 mm and, preferably, at least 18 mm or at least 20 mm.

In some embodiments, an aerosol-modifying agent is applied to the body of material.

In some embodiments, an aerosol-former material is applied to the body of material.

In some embodiments, aerosol-former material comprises one or more of glycerine, glycerol, propylene glycol, diethylene glycol, triethylene glycol, tetraethylene glycol, 1,3-butylene glycol, erythritol, meso-Erythritol, ethyl vanillate, ethyl laurate, a diethyl suberate, triethyl citrate, triacetin, a diacetin mixture, benzyl benzoate, benzyl phenyl acetate, tributyrin, lauryl acetate, lauric acid, myristic acid, and propylene carbonate.

In some embodiments, at least 0.02 mg of aerosol-former material is applied to the body of material per 1 mm axial length of the body of material and, preferably, at least 0.03, 0.04 or 0.05 mg of aerosol-former material is applied to the body of material per 1 mm axial length of the body of material.

In some embodiments, 0.5 mg or less of aerosol-former material is applied to the body of material per 1 mm axial length of the body of material and, preferably, 0.4 mg or less, 0.3 mg or less, 0.2 mg or less, or 0.1 mg or less of aerosol-former material is applied to the body of material per 1 mm axial length of the body of material.

In some embodiments, the article further comprises a tube and, preferably, the tube is a paper tube.

In some embodiments, the tube has an axial length of at least 20 mm and, preferably, at least 23 mm.

In some embodiments, the tube is downstream of the body of material and, optionally, a downstream end of the mouthpiece comprises an end of the tube.

In some embodiments, the body of material and tube are adjacent.

In some embodiments, the tube comprises one or more ventilation holes.

In some embodiments, the article comprises a tubular portion downstream of the body of material, and, preferably, the tubular portion comprises paper or cellulose acetate.

In some embodiments, the article comprises a tubular element located within the body of material, the tubular element comprising a cavity.

In some embodiments, the tubular element is located substantially radially centrally within the body of material.

In some embodiments, the tubular element extends to a downstream end of the body of material.

In some embodiments, the tubular element in manufactured from paper.

In some embodiments, the tubular element has a length of at least 4 mm and, preferably, a length of about 5 mm.

In some embodiments, the downstream portion has a hardness in the range of about 80% to 95% and, preferably, in the range of about 85% to 90%. In some embodiments, the hardness of the downstream portion may be at least 80% and, preferably, at least 81%, 82%, 83%, 84%, 85%, 86%, 87%, 88%, 89%, 90% or 91% 92%. A hardness of at least 80% helps to ensure that the downstream portion can be processed, as otherwise a downstream portion that is too soft may become jammed or misaligned in the manufacturing machinery.

In some embodiments, the body of portion surrounded by a wrapper has a hardness in the range of about 80% to 95% and, preferably, in the range of about 85% to 90%. In some embodiments, the hardness of the body portion and wrapper may be at least 80% and, preferably, at least 81%, 82%, 83%, 84%, 85%, 86%, 87%, 88%, 89%, 90% or 91% 92%.

In some embodiments, the roundness of the article at the downstream portion is at least 90% and, preferably, is at least 91%, 92%, 93%, 94% or 95%.

In some embodiments, the roundness of the body portion surrounded by a wrapper is at least 90% and, preferably, is at least 91%, 92%, 93%, 94% or 95%.

In some embodiments, the aerosol generating material comprises a first aerosol generating material, and the article further comprises a component downstream of the first aerosol generating material, wherein the component comprises a tubular portion and wherein the tubular portion comprises a wall comprising a second aerosol generating material.

In some embodiments, the aerosol generating material is wrapped by a wrapper having a level of permeability greater than about 2000 Coresta Units, and wherein the article comprises a downstream portion downstream of the aerosol generating material, comprising at least one ventilation area.

In some embodiments, the article is configured such that when the article is inserted into a non-combustible aerosol provision device, the minimum distance between a heater of the non-combustible aerosol provision device and a tubular section of the article is at least about 3 mm.

In some embodiments, the level of ventilation provided by said one or more ventilation holes is within the range of 45% to 65% of the volume of aerosol passing through the component, or between 40% and 60% of the volume of aerosol passing through the component.

In some embodiments, the article comprises a hollow tubular element extending from a mouth end of the article, wherein the hollow tubular element comprises a length of greater than about 10 mm or greater than about 12 mm.

In some embodiments, the article comprises at least one aerosol modifying agent release component incorporated within the body of material.

In some embodiments, the aerosol modifying agent release component comprises a capsule.

In some embodiments, the aerosol modifying agent release component being incorporated with the body may mean that the aerosol modifying agent release component are disposed within the body or disposed on an outer surface of the body.

In some embodiments, the capsule comprises a solid shell and a liquid core.

In some embodiments, the or each capsule has a burst strength in the range 5 to 30 N.

In some embodiments, the aerosol modifying agent release component has a diameter in the range of 2.8 mm and 4 mm and, preferably, in the range of 2.8 mm and 3.6 mm.

In some embodiments, the article is an article for a non-combustible aerosol provision system.

In some embodiments, the article is an article for a combustible aerosol provision system.

According to the present disclosure, there is also provided an aerosol provision system comprising an article as described herein.

In some embodiments, the aerosol provision system is a non-combustible aerosol provision system.

In some embodiments, the non-combustible aerosol provision system is an aerosol generating material heating system and, preferably is a tobacco heating system.

### BRIEF DESCRIPTION OF THE DRAWINGS

Embodiments of the invention will now be described, by way of non-limiting example only, with reference to the accompanying drawings, in which:

FIG. 1 is a side-on cross sectional view of an embodiment of an article for use with a non-combustible aerosol provision device, the article including a mouthpiece

FIG. 2 is a cross-sectional end view of a body of material of the article, along the line A-A of FIG. 1;

FIG. 3 is a side-on cross sectional view of another embodiment of an article for use with a non-combustible aerosol provision device;

FIG. 4 is a side-on cross sectional view of another embodiment of an article for use with a non-combustible aerosol provision device;

FIG. 5 is a side-on cross sectional view of another embodiment of an article for use with a non-combustible aerosol provision device;

FIG. 6 is a side-on cross sectional view of a multiple length rod for manufacture of a body of material of the article of FIG. 5;

FIG. 7 is a perspective illustration of a non-combustible aerosol provision device for generating aerosol from the aerosol generating material of the article of FIGS. 1 to 6;

FIG. 8 illustrates the device of FIG. 7 with the outer cover removed and without an article present;

FIG. 9 is a side view of the device of FIG. 8 in partial cross-section;

FIG. 10 is an exploded view of the device of FIG. 8, with the outer cover omitted;

FIG. 11A is a cross sectional view of a portion of the device of FIG. 8; and,

FIG. 11B is a close-up illustration of a region of the device of FIG. 11A.

### DETAILED DESCRIPTION

According to the present disclosure, an “aerosol provision system” includes both combustible aerosol provision systems and non-combustible aerosol provision systems.

According to the present disclosure, a “combustible” aerosol provision system is one where a constituent aerosol-generating material of the aerosol provision system (or component thereof) is combusted or burned during use in order to facilitate delivery of at least one substance to a user.

In some embodiments, the delivery system is a combustible aerosol provision system, such as a system selected from the group consisting of a cigarette, a cigarillo and a cigar.

In some embodiments, the disclosure relates to a component for use in a combustible aerosol provision system, such as a filter, a filter rod, a filter segment, a tobacco rod, a spill, an aerosol-modifying agent release component such as a capsule, a thread, or a bead, or a paper such as a plug wrap, a tipping paper or a cigarette paper.

According to the present disclosure, a “non-combustible” aerosol provision system is one where a constituent aerosol-generating material of the aerosol provision system (or component thereof) is not combusted or burned in order to facilitate delivery of at least one substance to a user.

In some embodiments, the delivery system is a non-combustible aerosol provision system, such as a powered non-combustible aerosol provision system.

In some embodiments, the non-combustible aerosol provision system is an electronic cigarette, also known as a vaping device or electronic nicotine delivery system (END), although it is noted that the presence of nicotine in the aerosol-generating material is not a requirement.

In some embodiments, the non-combustible aerosol provision system is an aerosol-generating material heating system, also known as a heat-not-burn system. An example of such a system is a tobacco heating system.

In some embodiments, the non-combustible aerosol provision system is a hybrid system to generate aerosol using a combination of aerosol-generating materials, one or a plurality of which may be heated. Each of the aerosol-generating materials may be, for example, in the form of a solid, liquid or gel and may or may not contain nicotine. In some embodiments, the hybrid system comprises a liquid or gel aerosol-generating material and a solid aerosol-generating material. The solid aerosol-generating material may comprise, for example, tobacco or a non-tobacco product.

Typically, the non-combustible aerosol provision system may comprise a non-combustible aerosol provision device and a consumable for use with the non-combustible aerosol provision device.

In some embodiments, the disclosure relates to consumables comprising aerosol-generating material and configured to be used with non-combustible aerosol provision devices. These consumables are sometimes referred to as articles throughout the disclosure.

In some embodiments, the non-combustible aerosol provision system, such as a non-combustible aerosol provision device thereof, may comprise a power source and a controller. The power source may, for example, be an electric power source or an exothermic power source. In some embodiments, the exothermic power source comprises a carbon substrate which may be energised so as to distribute power in the form of heat to an aerosol-generating material or to a heat transfer material in proximity to the exothermic power source.

In some embodiments, the non-combustible aerosol provision system may comprise an area for receiving the consumable, an aerosol generator, an aerosol generation area, a housing, a mouthpiece, a filter and/or an aerosol-modifying agent.

In some embodiments, the consumable for use with the non-combustible aerosol provision device may comprise aerosol-generating material, an aerosol-generating material storage area, an aerosol-generating material transfer component, an aerosol generator, an aerosol generation area, a housing, a wrapper, a filter, a mouthpiece, and/or an aerosol-modifying agent.

In some embodiments, the substance to be delivered comprises an active substance.

The active substance as used herein may be a physiologically active material, which is a material intended to achieve or enhance a physiological response. The active substance may for example be selected from nutraceuticals, nootropics, psychoactives. The active substance may be naturally occurring or synthetically obtained. The active substance may comprise for example nicotine, caffeine, taurine, theine, vitamins such as B6 or B12 or C, melatonin, cannabinoids, or constituents, derivatives, or combinations thereof. The active substance may comprise one or more constituents, derivatives or extracts of tobacco, cannabis or another botanical.

In some embodiments, the active substance comprises nicotine. In some embodiments, the active substance comprises caffeine, melatonin or vitamin B12.

As noted herein, the active substance may comprise or be derived from one or more botanicals or constituents, derivatives or extracts thereof. As used herein, the term “botanical” includes any material derived from plants including, but not limited to, extracts, leaves, bark, fibres, stems, roots, seeds, flowers, fruits, pollen, husk, shells or the like. Alternatively, the material may comprise an active compound naturally existing in a botanical, obtained synthetically. Example botanicals are tobacco, eucalyptus, star anise, hemp, cocoa, cannabis, fennel, lemongrass, peppermint, spearmint, rooibos, chamomile, flax, ginger, Ginkgo biloba, hazel, hibiscus, laurel, licorice (liquorice), matcha, mate, orange skin, papaya, rose, sage, tea such as green tea or black tea, thyme, clove, cinnamon, coffee, aniseed (anise), basil, bay leaves, cardamom, coriander, cumin, nutmeg, oregano, paprika, rosemary, saffron, lavender, lemon peel, mint, juniper, elderflower, vanilla, wintergreen, beefsteak plant, curcuma, turmeric, sandalwood, cilantro, bergamot, orange blossom, myrtle, cassis, valerian, pimento, mace, damien, marjoram, olive, lemon balm, lemon basil, chive, carvi, verbena, tarragon, geranium, mulberry, ginseng, theanine, theacrine, maca, ashwagandha, damiana, guarana, chlorophyll, baobab or any combination thereof. The mint may be chosen from the following mint varieties: Mentha arventis, Mentha c.v., Mentha niliaca, Mentha piperita, Mentha piperita citrata c.v., Mentha piperita c.v, Mentha spicata crispa, Mentha cardifolia, Mentha longifolia, Mentha suaveolens variegata, Mentha pulegium, Mentha spicata c.v. and Mentha suaveolens In some embodiments, the active substance comprises or is derived from one or more botanicals or constituents, derivatives or extracts thereof and the botanical is tobacco.

In some embodiments, the active substance comprises or derived from one or more botanicals or constituents, derivatives or extracts thereof and the botanical is selected from eucalyptus, star anise, cocoa and hemp.

In some embodiments, the active substance comprises or derived from one or more botanicals or constituents, derivatives or extracts thereof and the botanical is selected from rooibos and fennel.

In some embodiments, the substance to be delivered comprises a flavour.

As used herein, the terms “flavour” and “flavourant” refer to materials which, where local regulations permit, may be used to create a desired taste, aroma or other somatosensorial sensation in a product for adult consumers. They may include naturally occurring flavour materials, botanicals, extracts of botanicals, synthetically obtained materials, or combinations thereof (e.g., tobacco, cannabis, licorice (liquorice), hydrangea, eugenol, Japanese white bark magnolia leaf, chamomile, fenugreek, clove, maple, matcha, menthol, Japanese mint, aniseed (anise), cinnamon, turmeric, Indian spices, Asian spices, herb, wintergreen, cherry, berry, red berry, cranberry, peach, apple, orange, mango, clementine, lemon, lime, tropical fruit, papaya, rhubarb, grape, durian, dragon fruit, cucumber, blueberry, mulberry, citrus fruits, Drambuie, bourbon, scotch, whiskey, gin, tequila, rum, spearmint, peppermint, lavender, aloe vera, cardamom, celery, cascarilla, nutmeg, sandalwood, bergamot, geranium, khat, naswar, betel, shisha, pine, honey essence, rose oil, vanilla, lemon oil, orange oil, orange blossom, cherry blossom, cassia, caraway, cognac, jasmine, ylang-ylang, sage, fennel, wasabi, piment, ginger, coriander, coffee, hemp, a mint oil from any species of the genus Mentha, eucalyptus, star anise, cocoa, lemongrass, rooibos, flax, Ginkgo biloba, hazel, hibiscus, laurel, mate, orange skin, rose, tea such as green tea or black tea, thyme, juniper, elderflower, basil, bay leaves, cumin, oregano, paprika, rosemary, saffron, lemon peel, mint, beefsteak plant, curcuma, cilantro, myrtle, cassis, valerian, pimento, mace, damien, marjoram, olive, lemon balm, lemon basil, chive, carvi, verbena, tarragon, limonene, thymol, camphene), flavour enhancers, bitterness receptor site blockers, sensorial receptor site activators or stimulators, sugars and/or sugar substitutes (e.g., sucralose, acesulfame potassium, aspartame, saccharine, cyclamates, lactose, sucrose, glucose, fructose, sorbitol, or mannitol), and other additives such as charcoal, chlorophyll, minerals, botanicals, or breath freshening agents. They may be imitation, synthetic or natural ingredients or blends thereof. They may be in any suitable form, for example, liquid such as an oil, solid such as a powder, or gas.

In some embodiments, the flavour comprises menthol, spearmint and/or peppermint. In some embodiments, the flavour comprises flavour components of cucumber, blueberry, citrus fruits and/or redberry. In some embodiments, the flavour comprises eugenol. In some embodiments, the flavour comprises flavour components extracted from tobacco. In some embodiments, the flavour comprises flavour components extracted from cannabis.

In some embodiments, the flavour may comprise a sensate, which is intended to achieve a somatosensorial sensation which are usually chemically induced and perceived by the stimulation of the fifth cranial nerve (trigeminal nerve), in addition to or in place of aroma or taste nerves, and these may include agents providing heating, cooling, tingling, numbing effect. A suitable heat effect agent may be, but is not limited to, vanillyl ethyl ether and a suitable cooling agent may be, but not limited to eucolyptol, WS-3.

Aerosol-generating material is a material that is capable of generating aerosol, for example when heated, irradiated or energized in any other way. Aerosol-generating material may, for example, be in the form of a solid, liquid or gel which may or may not contain an active substance and/or flavourants. In some embodiments, the aerosol-generating material may comprise an “amorphous solid”, which may alternatively be referred to as a “monolithic solid” (i.e. non-fibrous). In some embodiments, the amorphous solid may be a dried gel. The amorphous solid is a solid material that may retain some fluid, such as liquid, within it. In some embodiments, the aerosol-generating material may for example comprise from about 50 wt %, 60 wt % or 70 wt % of amorphous solid, to about 90 wt %, 95 wt % or 100 wt % of amorphous solid.

The aerosol-generating material may comprise one or more active substances and/or flavours, one or more aerosol-former materials, and optionally one or more other functional material.

The aerosol-former material may comprise one or more constituents capable of forming an aerosol. In some embodiments, the aerosol-former material may comprise one or more of glycerine, glycerol, propylene glycol, diethylene glycol, triethylene glycol, tetraethylene glycol, 1,3-butylene glycol, erythritol, meso-Erythritol, ethyl vanillate, ethyl laurate, a diethyl suberate, triethyl citrate, triacetin, a diacetin mixture, benzyl benzoate, benzyl phenyl acetate, tributyrin, lauryl acetate, lauric acid, myristic acid, and propylene carbonate.

The one or more other functional materials may comprise one or more of pH regulators, colouring agents, preservatives, binders, fillers, stabilizers, and/or antioxidants.

The material may be present on or in a support, to form a substrate. The support may, for example, be or comprise paper, card, paperboard, cardboard, reconstituted material, a plastics material, a ceramic material, a composite material, glass, a metal, or a metal alloy. In some embodiments, the support comprises a susceptor. In some embodiments, the susceptor is embedded within the material. In some alternative embodiments, the susceptor is on one or either side of the material.

A consumable is an article comprising or consisting of aerosol-generating material, part or all of which is intended to be consumed during use by a user. A consumable may comprise one or more other components, such as an aerosol-generating material storage area, an aerosol-generating material transfer component, an aerosol generation area, a housing, a wrapper, a mouthpiece, a filter and/or an aerosol-modifying agent. A consumable may also comprise an aerosol generator, such as a heater, that emits heat to cause the aerosol-generating material to generate aerosol in use. The heater may, for example, comprise combustible material, a material heatable by electrical conduction, or a susceptor.

A susceptor is a material that is heatable by penetration with a varying magnetic field, such as an alternating magnetic field. The susceptor may be an electrically-conductive material, so that penetration thereof with a varying magnetic field causes induction heating of the heating material. The heating material may be magnetic material, so that penetration thereof with a varying magnetic field causes magnetic hysteresis heating of the heating material. The susceptor may be both electrically-conductive and magnetic, so that the susceptor is heatable by both heating mechanisms. The device that is configured to generate the varying magnetic field is referred to as a magnetic field generator, herein.

An aerosol-modifying agent is a substance that is configured to modify the aerosol generated, for example by changing the taste, flavour, acidity or another characteristic of the aerosol. The aerosol-modifying agent may be provided in an aerosol-modifying agent release component, that is operable to selectively release the aerosol-modifying agent

The aerosol-modifying agent may, for example, be an additive or a sorbent. The aerosol-modifying agent may, for example, comprise one or more of a flavourant, a colourant, water, and a carbon adsorbent. The aerosol-modifying agent may, for example, be a solid, a liquid, or a gel. The aerosol-modifying agent may be in powder, thread or granule form. The aerosol-modifying agent may be free from filtration material.

An aerosol generator is an apparatus configured to cause aerosol to be generated from the aerosol-generating material. In some embodiments, the aerosol generator is a heater configured to subject the aerosol-generating material to heat energy, so as to release one or more volatiles from the aerosol-generating material to form an aerosol. In some embodiments, the aerosol generator is configured to cause an aerosol to be generated from the aerosol-generating material without heating. For example, the aerosol generator may be configured to subject the aerosol-generating material to one or more of vibration, increased pressure, or electrostatic energy.

Articles, for instance those in the shape of rods, are often named according to the product length: “regular” (typically in the range 68-75 mm, e.g. from about 68 mm to about 72 mm), “short” or “mini” (68 mm or less), “king-size” (typically in the range 75-91 mm, e.g. from about 79 mm to about 88 mm), “long” or “super-king” (typically in the range 91-105 mm, e.g. from about 94 mm to about 101 mm) and “ultra-long” (typically in the range from about no mm to about 121 mm).

They are also named according to the product circumference: “regular” (about 23-25 mm), “wide” (greater than 25 mm), “slim” (about 22-23 mm), “demi-slim” (about 19-22 mm), “super-slim” (about 16-19 mm), and “micro-slim” (less than about 16 mm).

Accordingly, an article in a king-size, super-slim format will, for example, have a length of about 83 mm and a circumference of about 17 mm.

Each format may be produced with mouthpieces of different lengths. The mouthpiece length will be from about 30 mm to 50 mm. A tipping paper connects the mouthpiece to the aerosol generating material and will usually have a greater length than the mouthpiece, for example from 3 to 10 mm longer, such that the tipping paper covers the mouthpiece and overlaps the aerosol generating material, for instance in the form of a rod of substrate material, to connect the mouthpiece to the rod.

Articles and their aerosol generating materials and mouthpieces described herein can be made in, but are not limited to, any of the above formats.

The terms ‘upstream’ and ‘downstream’ used herein are relative terms defined in relation to the direction of mainstream aerosol drawn though an article or device in use.

The filamentary tow material described herein can comprise cellulose acetate fibre tow. The filamentary tow can also be formed using other materials used to form fibres, such as polyvinyl alcohol (PVOH), polylactic acid (PLA), polycaprolactone (PCL), poly(1-4 butanediol succinate) (PBS), poly(butylene adipate-co-terephthalate) (PBAT), starch based materials, cotton, aliphatic polyester materials and polysaccharide polymers or a combination thereof. The filamentary tow may be plasticised with a suitable plasticiser for the tow, such as triacetin where the material is cellulose acetate tow, or the tow may be non-plasticised. The tow can have any suitable specification, such as fibres having a ‘Y’ shaped or other cross section such as ‘X’ shaped, filamentary denier values between 2.5 and 15 denier per filament, for example between 8.0 and 11.0 denier per filament and total denier values of 5,000 to 50,000, for example between 10,000 and 40,000.

As used herein, the term “tobacco material” refers to any material comprising tobacco or derivatives or substitutes thereof. The term “tobacco material” may include one or more of tobacco, tobacco derivatives, expanded tobacco, reconstituted tobacco or tobacco substitutes. The tobacco material may comprise one or more of ground tobacco, tobacco fibre, cut tobacco, extruded tobacco, tobacco stem, tobacco lamina, reconstituted tobacco and/or tobacco extract.

In the figures described herein, like reference numerals are used to illustrate equivalent features, articles or components.

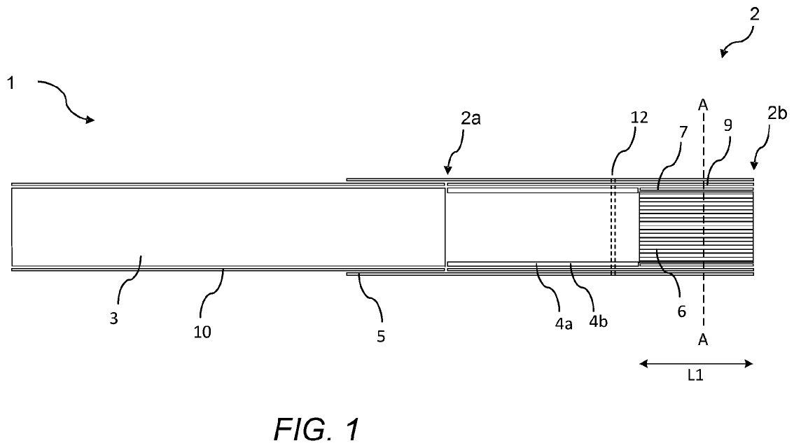

FIG. 1 is a side-on cross sectional view of an article 1 for use with a non-combustible aerosol provision system.

The article 1 comprises a mouthpiece 2, and a cylindrical rod of aerosol generating material 3, in the present case tobacco material, connected to the mouthpiece 2. The aerosol generating material 3 provides an aerosol when heated, for instance within a non-combustible aerosol provision device as described herein, for instance a non-combustible aerosol provision device comprising a coil, forming a system. In other embodiments the article 1 can include its own heat source, forming an aerosol provision system without requiring a separate aerosol provision device.

The aerosol generating material 3, also referred to herein as an aerosol generating substrate 3, comprises at least one aerosol-former material. In the present example, the aerosol-former material is glycerol. In alternative examples, the aerosol-former material can be another material as described herein or a combination thereof. The aerosol-former material has been found to improve the sensory performance of the article, by helping to transfer compounds such as flavour compounds from the aerosol generating material to the consumer. However, an issue with adding such aerosol-former materials to the aerosol generating material within an article for use in a non-combustible aerosol provision system can be that, when the aerosol-former material is aerosolised upon heating, it can increase the mass of aerosol which is delivered by the article, and this increased mass can maintain a higher temperature as it passes through the mouthpiece. As it passes through the mouthpiece, the aerosol transfers heat into the mouthpiece and this warms the outer surface of the mouthpiece, including the area which comes into contact with the consumers lips during use. The mouthpiece temperature can be significantly higher than consumers may be accustomed to when smoking, for instance, conventional cigarettes, and this can be an undesirable effect caused by the use of such aerosol-former materials.

In the present example, the mouthpiece includes a tubular portion 4a, in the present example formed by a hollow tube, also referred to as a cooling element. The mouthpiece 2, in the present example, includes a body of material 6 downstream of the tubular portion 4a, in this example adjacent to and in an abutting relationship with the tubular portion 4a. The body of material 6 and tubular portion 4a each define a substantially cylindrical overall outer shape and share a common longitudinal axis.

The body of material 6 is wrapped in a first plug wrap 7. In the present example, the tubular portion 4a and body of material 6 are combined using a second plug wrap 9 which is wrapped around both sections. A tipping paper 5 is wrapped around the full length of the mouthpiece 2 and over part of the rod of aerosol generating material 3 and has an adhesive on its inner surface to connect the mouthpiece 2 and rod 3.

In the present example, the tubular portion 4a is formed from a plurality of layers of paper which are parallel wound, with butted seams, to form a hollow tube. In the present example, first and second paper layers are provided in a two-ply tube, although in other examples 3, 4 or more paper layers can be used forming 3, 4 or more ply tubes. Other constructions can be used, such as spirally wound layers of paper, cardboard tubes, tubes formed using a papier-mâché type process, moulded or extruded plastic tubes or similar.

In some embodiments, the tubular portion preferably has a wall thickness of at least about 325 μm and up to about 2 mm, preferably between 500 μm and 1.5 mm and more preferably between 750 μm and 1 mm. In the present example, the tubular portion has a wall thickness of about 1 mm. The “wall thickness” of the tubular portion corresponds to the thickness of the wall of the tubular portion in a radial direction. This may be measured, for example, using a caliper.

In some embodiments, the thickness of the wall of the tubular portion is at least 325 microns and, preferably, at least 400, 500, 600, 700, 800, 900 or 1000 microns. In some embodiments, the thickness of the wall of the tubular portion is at least 1250 or 1500 microns.

In some embodiments, the thickness of the wall of the tubular portion is less than 2000 microns and, preferably, less than 1500 microns.

The increased thickness of the wall of the tubular portion means that it has a greater thermal mass, which has been found to help reduce the temperature of the aerosol passing through the tubular portion and reduce the surface temperature of the mouthpiece at locations downstream of the tubular portion. This is thought to be because the greater thermal mass of the tubular portion allows the tubular portion to absorb more heat from the aerosol in comparison to a tubular portion with a thinner wall thickness. The increased thickness of the tubular portion also channels the aerosol centrally within the mouthpiece such that less heat from the aerosol is transferred to the outer portions of the mouthpiece such as outer portions of the body of material.

In some embodiments, the permeability of the material of the wall of the tubular portion 4a is at least 100 Coresta Units and, preferably, at least 500 or 1000 Coresta Units.

It has been found that the relatively high permeability of the tubular portion increases the amount of heat that is transferred to the tubular portion from the aerosol and thus reduces the temperature of the aerosol. The permeability of the tubular portion has also been found to increase the amount of moisture that is transferred from the aerosol to the tubular portion, which has been found to improve the feel of the aerosol in the user's mouth. A high permeability of tubular portion also makes it easier to cut the ventilation holes using a laser, meaning that a lower power of laser can be used.

The article 1 has a ventilation level of about 75% of the aerosol drawn through the article. In alternative embodiments, the article can have a ventilation level of between 50% and 80% of aerosol drawn through the article, for instance between 65% and 75%. Ventilation at these levels helps to slow down the flow of aerosol drawn through the mouthpiece 2 and thereby enable the aerosol to cool sufficiently before it reaches a downstream end 2b of the mouthpiece 2. The ventilation is provided directly into the mouthpiece 2 of the article 1. In the present example, the ventilation is provided into the tubular portion 4a, which has been found to be particularly beneficial in assisting with the aerosol generation process. The ventilation is provided via first and second parallel rows of ventilation holes 12, in the present case formed as laser perforations, at positions 17.925 mm and 18.625 mm respectively from the downstream, mouth-end 2b of the mouthpiece 2. These ventilation holes 12 pass though the tipping paper 5, second plug wrap 9 and tubular portion 4a. In alternative embodiments, the ventilation can be provided into the mouthpiece at other locations. For example, the ventilation may be provided into the body of material 6.

Alternatively, the ventilation can be provided via a single row of ventilation holes, for instance laser perforations, into the portion of the article in which the tubular body 4a is located. This has been found to result in improved aerosol formation, which is thought to result from the airflow through the ventilation holes being more uniform than with multiple rows of ventilation holes, for a given ventilation level.

Aerosol temperature has been found to generally increase with a drop in the ventilation level. However the relationship between aerosol temperature and ventilation level does not appear to be linear, with variations in ventilation, for instance due to manufacturing tolerances, having less impact at lower target ventilation levels. For instance, with a ventilation tolerance of ±15%, for a target ventilation level of 75%, the aerosol temperature could increase by approximately 6° C. at the lower ventilation limit (60% ventilation). However, with a target ventilation level of 60% the aerosol temperature may only increase by approximately 3.5° C. at the lower vent limit (45% ventilation). The target ventilation level of the article can therefore be within the range 40% to 70%, for instance, 45% to 65%. The mean ventilation level of at least 20 articles can be between 40% and 70%, for instance between 45% and 70% or between 51% and 59%.

In some examples, the aerosol generating material 3 described herein is a first aerosol generating material and the tubular portion 4a may include a second aerosol generating material. In one example, wall 4b of tubular portion 4a comprises the second aerosol generating material. For example, the second aerosol generating material can be disposed on an inner surface of wall 4b of the tubular portion 4a.

The second aerosol generating material comprises at least one aerosol former material, and may also comprise at least one aerosol modifying agent, or other sensate material. The aerosol former material and/or aerosol modifying agent can be any aerosol former material or aerosol modifying agent as described herein, or a combination thereof.

As the aerosol generated from aerosol generating material 3, referred to herein as the first aerosol, is drawn through the tubular portion 4a of the mouthpiece, heat from the first aerosol may aerosolise the aerosol forming material of the second aerosol generating material, to form a second aerosol. The second aerosol may comprise a flavourant, which may be additional or complementary to the flavour of the first aerosol.

Providing a second aerosol generating material on the tubular body 4a can result in generation of a second aerosol which boosts or complements the flavour or visual appearance of the first aerosol.

In the present example, the article 1 has an outer circumference of about 21 mm (i.e. the article is in the demi-slim format). Preferably, the article 1 has a rod of aerosol generating material having a circumference greater than 19 mm. This has been found to provide a sufficient circumference to generate an improved and sustained aerosol over a usual aerosol generation session preferred by consumers. As the article is heated, heat transfers through the rod of aerosol generating material 3 to volatise components of the rod, and circumferences greater than 19 mm have been found to be particularly effective at producing an aerosol in this way. Since the article is to be heated to release an aerosol, improved heating efficiency can be achieved using articles having circumferences of less than about 23 mm. To achieve improved aerosol via heating, while maintaining a suitable product length, rod circumferences of greater than 19 mm and less than 23 mm are preferable. In some examples, the rod circumference can be between 20 mm and 22 mm, which has been found to provide a good balance between providing effective aerosol delivery while allowing for efficient heating.

The outer circumference of the mouthpiece 2 is substantially the same as the outer circumference of the rod of aerosol generating material 3, such that there is a smooth transition between these components. In the present example, the outer circumference of the mouthpiece 2 is about 20.8 mm.

In some examples, the tipping paper 5 comprises citrate, such as sodium citrate or potassium citrate. In such examples, the tipsheeting paper 5 may have a citrate content of 2% by weight or less, or 1% by weight or less. Reducing the citrate content of the tipping paper 5 is thought to assist with reducing the charring effect which may occur during use.

In the present example, the tipping paper 5 extends 5 mm over the rod of aerosol generating material 3 but it can alternatively extend between 3 mm and 10 mm over the rod 3, or more preferably between 4 mm and 6 mm, to provide a secure attachment between the mouthpiece 2 and rod 3. The tipping paper 5 can have a basis weight which is higher than the basis weight of plug wraps used in the article 1, for instance a basis weight of 40 gsm to 80 gsm, more preferably between 50 gsm and 70 gsm, and in the present example 58 gsm. These ranges of basis weights have been found to result in tipping papers having acceptable tensile strength while being flexible enough to wrap around the article 1 and adhere to itself along a longitudinal lap seam on the paper.

The outer circumference of the tipping paper 5, once wrapped around the mouthpiece 2, is about 21 mm.

In some embodiments, the first plug wrap 7 has a basis weight of less than 50 gsm, more preferably between about 20 gsm and 40 gsm. However, it should be recognised that the basis weight of the first plug wrap 7 may be higher to increase the hardness of the mouthpiece. For instance, the basis weight of the first plug wrap 7 may be at least 50, 60, 70, 80, 90 or 100 gsm. In some embodiments, the basis weight of the first plug wrap 7 is in the range of 50 to 110 gsm, or in the range of 60 to 100 gsm.

In some embodiments, the first plug wrap 7 has a basis weight or at least 20 gsm or at least 30 gsm.

In some embodiments, the first plug wrap 7 has a basis weight of at most 120, 110 or 100 gsm.

In some embodiments, the first plug wrap 7 has a basis weight in the range of 20 to 120 gsm and, preferably, in the range of 30 to 100 gsm.

Preferably, the first plug wrap 7 has a thickness of between 30 μm and 60 μm, more preferably between 35 μm and 45 μm. However, it should be recognised that the thickness weight of the first plug wrap 7 may be higher to increase the hardness of the mouthpiece. In some embodiments, for example, the thickness of the first plug wrap 7 may be at least 40, 50, 60, 70, 80, 90 or 100 microns. In some embodiments, the thickness of the first plug wrap 7 is in the range of 40 to 120 microns, or in the range of 50 to 100 microns.

Preferably, the first plug wrap 7 is a non-porous plug wrap, for instance having a permeability of less than 100 Coresta units, for instance less than 50 Coresta units. However, in other embodiments, the first plug wrap 7 can be a porous plug wrap, for instance having a permeability of greater than 200 Coresta Units. Preferably, the length of the body of material 6 is less than about 20 mm. In the present example, the length of the body of material 6 is 16 mm.

In some embodiments, the axial length of the body of material 6 is in the range of 10 to 20 mm.

In the present example, the body of material 6 is formed from a sheet material 6A arranged into the body of material 6. The sheet material 6A may be folded to form the body of material 6. The body of material 6 may be formed from a continuous web of sheet material 6A. In the present example, the sheet material 6A is gathered to form the body of material 6 is a similar manner to a ‘crepe filter’. The sheet material 6A may be manufactured using a CU-20 filter making machine manufactured by Decouflé™. However, a skilled person will appreciate that other machines may be used to manufacture the body of material 6.

In some embodiments, the continuous web of sheet material 6A has a width of at least 60 mm and, preferably, at least 70, 80, 90, 100, 110 or 120 mm.

In some embodiments, the continuous web of sheet material 6A has a width of at most 240 mm and, preferably, at most 230, 220, 210, 200, 190, 180, 170, 160 or 150 mm.

In some embodiments, the continuous web of sheet material 6A has a width of less than 180 mm and, preferably, less than 170, 160, 150, 140 or 130 mm.

In some embodiments, the sheet material has a width in the range of 60 to 240 mm and, preferably, in the range of 80 to 240 mm, in the range of 90 to 200 mm, or in the range of 100 to 170 mm.

In the present example, the sheet material 6A comprises cellulose. In the present example, the sheet material 6A is paper. However, the sheet material 6A may additionally or alternatively comprise a different material. For example, in some embodiments the sheet material 6A comprises reconstituted tobacco that is formed into a sheet material 6A that is arranged to form the body of material 6. The reconstituted tobacco comprises cellulose. In another embodiment (not shown), the reconstituted tobacco is manufactured into a uniform plug of material that forms the body 6. The reconstituted tobacco may optionally be paper reconstituted tobacco.

In one embodiment, the sheet material 9A comprises paper with a basis weight in the range of 15 to 80 gsm and, preferably, in the range of 20 to 50 gsm.

In some embodiments, the sheet material 6a has a basis weight of at least 15 gsm and, preferably, at least 20 gsm, 25 gsm, 30 gsm, 35 gsm, 40 gsm, 45 gsm, 50 gsm, 55 gsm or 60 gsm.

In some embodiments, the sheet material has a basis weight of 100 gsm or less and, preferably, 90 gsm or less, 80 gsm or less, 70 gsm or less, 60 gsm or less, 50 gsm or less, or 40 gsm or less, or 30 gsm or less. In some embodiments, the basis weight of the sheet material is 20 gsm or less.

In some embodiments, the sheet material has a basis weight in the range of 20 to 100 gsm and, preferably in the range of 25 to 80 gsm or in the range of 30 to 65 gsm.

In some embodiments, an aerosol-former material is applied to the body of material 6. For example, the aerosol-former material may be applied to the sheet material 6A prior to the sheet material 6A being folded to form the body of material 6. The aerosol-former material may be sprayed on to the sheet material 6A or applied by a brush or by dipping the sheet material 6 in aerosol-former material.

In some embodiments, the aerosol-former material may comprise one or more of glycerine, glycerol, propylene glycol, diethylene glycol, triethylene glycol, tetraethylene glycol, 1,3-butylene glycol, erythritol, meso-Erythritol, ethyl vanillate, ethyl laurate, a diethyl suberate, triethyl citrate, triacetin, a diacetin mixture, benzyl benzoate, benzyl phenyl acetate, tributyrin, lauryl acetate, lauric acid, myristic acid, and propylene carbonate.

In some embodiments, at least 0.02 mg of aerosol-former material is applied to the body of material per 1 mm axial length of the body of material. Preferably, at least 0.03, 0.04 or 0.05 mg of aerosol-former material is applied to the body of material per 1 mm axial length of the body of material.

In some embodiments, 0.5 mg or less of aerosol-former material is applied to the body of material per 1 mm axial length of the body of material. Preferably, 0.4 mg or less, 0.3 mg or less, 0.2 mg or less, or 0.1 mg or less of aerosol-former material is applied to the body of material per 1 mm axial length of the body of material.

At least some of the aerosol-former material is combined with the aerosol as it passes through the body of material 6 and helps to make the aerosol feel less dry within the user's mouth.

In some embodiments, the body of material 6 has an outer volume of at least 115 mm³. In the present example, the body of material 6 is generally cylindrical and thus has a generally cylindrical outer volume. It should be recognised that in other embodiments the body of material 6 may have an outer volume that is smaller than 115 mm³.

In the present example, the width W1 of the body of material 6 (which in the present example corresponds to the diameter of the body of material 6) is about 6.36 mm and the axial length L1 of the body of material 6 is 10 mm. Thus, the outer volume of the body of material 6 is about 318 mm³.

It has been found that a body of material 6A comprising cellulose and having a volume of at least 115 mm³ helps to remove moisture from aerosol generated by the aerosol generating material 3 as the aerosol passes through the body of material 6A of the mouthpiece 2. That is, the cellulose containing sheet material 6A absorbs water from the aerosol. Removing moisture from the aerosol makes the aerosol feel cooler in the user's mouth.

In some embodiments, the body of material 6 has a volume of at least 19 mm³ per mm axial length of the body of material and, preferably, at least 25 mm³ per mm axial length or at least 30 mm³ per mm. For instance, if the body of material 6 has a volume of 19 mm³ per mm axial length, and a length L1 of 10 mm, then the volume of the body of material would be 190 mm³.

A larger volume of body of material 6A will generally be more effective at removing moisture from the aerosol. In some examples, the outer volume of the body of material 6 is at least 200, at least 300, at least 400, at least 500, at least 600, at least 700, at least 800, at least 900 or at least 1000 mm³.

In some embodiments, the axial length L1 of the body of material 6 is at least 4 mm, at least 5 mm, at least 6 mm, at least 7 mm, at least 8 mm, at least 9 mm, or at least 10 mm.

In some embodiments, the axial length L1 of the body of material 6 is in the range of about 5 to 20 mm and, preferably, 6 to 15 mm and, preferably, 6 to 10 mm.

In some embodiments, the width W1 of the body of material 6 is at least 4 mm, at least 5 mm, at least 6 mm, at least 7 mm, at least 8 mm or at least 9 mm.

In some embodiments, the circumference of the body of material 6 is at least 16 mm, at least 18 mm, at least 20 mm, at least 22 mm, at least 25 mm or at least 28 mm.

In the present example, the sheet material 6A is crimped prior to being arranged into the body of material 6. For instance, the sheet material 6A may be passed through a pair of crimping rollers. The crimping may make it easier to gather the sheet material 6A to form the body of material 6. The crimping may also increase the length of sheet material 6A that can be used to form a body of material 6 of a particular volume. Increasing the amount of sheet material 6A in the body of material 6 may increase the surface area of sheet material 6A that is in contact with aerosol passing through the body of material 6 and thus increase the amount of moisture absorbed from the aerosol by the sheet material 6A.

In some embodiments, the sheet material is crimped to a crimp depth of at least 0.2 mm and, preferably, at least 0.3 mm, 0.4 mm or 0.5 mm.

In some embodiments, the sheet material is crimped to a crimp depth of at most 0.8 mm and, preferably, at most 0.6 mm, or 0.5 mm.

The crimp depth (also known as “crimping factor”) refers to the depth of the grooves the crimping forms in the sheet material. That is, crimping the sheet material produces a plurality of troughs in the sheet material when viewed from a first side of the sheet material, wherein the crimp depth is the depth of the troughs. The crimping may form a Zig-Zag formation.

In some embodiments, the sheet material 6A has a basis weight in the range of 15 to 80 gsm and, preferably, in the range of 20 to 50 gsm.

In some embodiments, the body 6 has a density of at least 0.05 mg/mm³ and, preferably, a density of at least 0.07 mg/mm³ and, preferably, at least 0.1 mg/mm³ and, preferably, at least 0.12 mg/mm³ or at least 0.15 mg/mm³. In the present example, the density of the body is about 0.13 mg/mm³.

In some embodiments, the pressure drop across the body of material 6 is at least 2 WGmm and, preferably, at least 3 mmWG and, preferably, at least 4 mmWG. The pressure drop across the body of material may be at least 5, 6, 7, 8, 9, 10 or 11 mmWG.

In some embodiments, the pressure drop across the body of material 6 is less than 20 mmWG and, probably, less than 16 mmWG and, preferably, less than 15, 14, 13 or 12 mmWG.

In some embodiments, the pressure drop across the body of material 6 is about 4.4, 8.1 or 11.9 mmWG.

In some embodiments, the pressure drop across the body of material 6 is in the range of 3 to 15 mmWG and, preferably, in the range of 4 to 12 mmWG.

In some embodiments, the pressure drop across the body of material 6 at least 0.2 mmWG per mm axial length of the body of material 6 and, preferably, at least 0.3, 0.4, 0.5, 0.6, 0.7, 0.8, 0.9, 1.0 or 1.1 mmWG per mm axial length of the body of material 6.

In some embodiments, the pressure drop across the body of material 6 is less than 2 mmWG per mm axial length of the body of material 6 and, preferably is less than 1.6, 1.5, 1.4, 1.3 or 1.2 mmWG per mm axial length of the body of material 6.

In some embodiments, the pressure drop across the body of material 6 is in the range of 0.3 to 1.5 mmWG per mm axial length of the body of material 6 and, preferably, is in the range of 0.4 to 1.2 mmWG per mm axial length of the body of material 6.

In some embodiments, the pressure drop across the body of material 6 is at least 2 mmWG and, preferably, at least 3 mmWG and, preferably, at least 4 mmWG, at least 6 mmWG, at least 8 mmWG, at least 10 mmWG or at least 11 mmWG, or at least 12 mmWG, or at least 15 mmWG, or at least 20 mmWG or at least 23 mmWG.

In some embodiments, the pressure drop across the body of material 6 is less than 25 mmWG and, preferably, less than 23 mmWG, less than 20 mmWG, less than 15 mmWG, less than 14 mmWG and, preferably, less than 12 mmWG or less than 10 mmWG.

In some embodiments, the pressure drop across the body of material 6 is in the range of 10 to 25 mmWG and, preferably, is in the range of 12 to 23 mmWG or 13 to 20 mmWG.

In some embodiments, the pressure drop across the body of material 6 is at least 0.2 mmWG per mm axial length of the body of material and, preferably, at least 0.3, 0.4, 0.6, or 0.8 mmWG per mm axial length of the body of material and, preferably, is at least 1, 1.1, 1.2, 1.5, 2 or 2.33 mmWG per mm axil length of the body of material.

In some embodiments, the pressure drop across the body of material 6 is less than 2.5 mmWG per mm axial length of the body of material and, preferably, is less than 2.3, 2, 1.5, 1.4, 1.2 or 1 mmWG per mm axial length of the body of material.

In some embodiments, the pressure drop across the body of material 6 is in the range of 1 to 2.5 mmWG per mm axial length of the body of material and, preferably, is in the range of 1.2 to 2.3 or 1.3 to 2 mmWG per mm axial length of the body of material.

In some embodiments having any of the above mentioned pressure drop values, the body of material 6 has an axial length of about 10 mm.

In some of the embodiments, the mass of body of material 6 is at least 20 mg and, preferably, at least 30 mg, at least 40 mg, at least 50 mg, at least 55 mg, or at least 60 mg. It has been advantageously found that providing a higher mass of the body of material 6 increases the amount of moisture that is absorbed form the aerosol. In the present example, the mass of the body of material is about 44 mg.

In some of the embodiments, the mass of body of material 6 is less than 150 mg and, preferably, less than 100 mg, less than 75 mg, less than 55 mg, less than 50 mg or less than 45 mg.

In some embodiments, the body of material 6 has a weight of at least 2 mg per mm axial length of the body of material and, preferably, at least 3 mg per mm axial length or at least 4 mg per mm axial length.

In the present example, the body of material 6 has a weight of about 4.4 mg per mm. That is, if the body of material 6 has an axial length L1 of 10 mm, as in the present example, then the mass would be about 44 mg.

In some embodiments, the body of material 6 is a solid cylindrical body of material.

In some embodiments, the mouthpiece 2 has a hardness in the range of about 80% to 95% and, preferably, in the range of about 85% to 90%. The hardness of the mouthpiece 2 may be at least 80% and, preferably, at least 81%, 82%, 83%, 84%, 85%, 86%, 87%, 88%, 89%, 90% or 91% 92%.

The hardness of the mouthpiece 2 may be measured according to the following protocol. Where the hardness of a section is referred to herein, the hardness is that as determined by the following measurement process. Any suitable device may be used for performing the measurement, such as the Borgwaldt Hardness Tester H10.

Hardness is defined as the ratio between the height h0 of a body and the height h1 of the body under a defined load, stated as a percentage of h0. Hardness may be expressed as:

Hardness=(h1/h0)×100

For an individual body, or a body contained in a multi-section rod, the hardness measurement is performed at the longitudinal centre point of the body.

A load bar is used to apply the defined load to the body. The length of the load bar should be significantly higher than that of the specimen to be measured. Prior to the hardness measurement, the body to be measured is conditioned according to ISO 3402 for a minimum of 48 hours, and is maintained in environmental conditions according to ISO 3402 during the measurement.

To perform the hardness measurement, a body is placed into the Hardness Tester H10, a pre-load of 2 g is applied to the body, and after 1 s the initial height h0 of the body under the 2 g pre-load is recorded. The pre-load is then removed and a load bar bearing a load of 150 g is lowered onto the sample at a rate of 0.6 mm/s, after 5 s the height h1 of the body under the 150 g load is measured.

The hardness of the mouthpiece is determined as the average hardness of at least 20 mouthpieces measured according to this protocol.

The hardness of the body of material 6 circumscribed by the first plug wrap 7 (hereinafter together referred to as the “component” for the purposes of determining the hardness) may also be determined using the above protocol, by carefully cutting the article to remove the body of material 6 surrounded by the first plug wrap 7. The hardness of the component may be at least 80% and, preferably, at least 81%, 82%, 83%, 84%, 85%, 86%, 87%, 88%, 89%, 90% or 91% 92%.

The expression “roundness” refers to the percentage conformity of the cross-sectional shape of the article/component to a perfect circle. The roundness is calculated according to Equation 1 below:

$$Roundness ( \% ) = ( 1 - \frac{2 ( X - Y )}{( X + Y )} ) \times 100 \qquad [ Equation 1 ]$$

To determine the roundness of the article 1 the maximum external diameter “X” of the component is measured using a caliper and the minimum external diameter “Y” of the article is measured using a caliper (the diameters being perpendicular to the central axis of the article 1). The less deviation between the maximum external diameter X and minimum external diameter Y of the article 1, the higher the roundness, which indicates that the cross-sectional shape of the article 1 is closer to a perfect circle.

In some embodiments, the roundness of the article 1 is at least 90% and, preferably, is at least 91%, 92%, 93%, 94% or 95%.

The hardness of the body of material 6 circumscribed by the first plug wrap 7 (hereinafter together referred to as the “component” for the purposes of determining the roundness) may also be determined using the above protocol, by carefully cutting the article to remove the body of material 6 surrounded by the first plug wrap 7.

To determine the roundness of the body of material 6 circumscribed by the first plug wrap 7 (hereinafter together referred to as “the component” for the purposes of determining the roundness) the maximum external diameter “X” of the component is measured using a caliper and the minimum external diameter “Y” of the component is measured using a caliper (the diameters being perpendicular to the central axis of the component). The less deviation between the maximum external diameter X and minimum external diameter Y of the component, the higher the roundness, which indicates that the cross-sectional shape of the component is closer to a perfect circle.

In some embodiments, the roundness of the component (i.e. the roundness of the body of material 6 circumscribed by the first plug wrap 7) is at least 90% and, preferably, is at least 91%, 92%, 93%, 94% or 95%.

The increased roundness of the article/component helps to ensure that the downstream portion can be processed, as otherwise a downstream portion that is too oval may become jammed or misaligned in the manufacturing machinery.

Preferably, the length of the tubular portion 4a is less than about 50 mm. More preferably, the length of the tubular portion 4a is less than about 40 mm. Still more preferably, the length of the tubular portion 4a is less than about 35 mm. In addition, or as an alternative, the length of the tubular portion 4a is preferably at least about 10 mm. Preferably, the length of the tubular portion 4a is at least about 15 mm.

In some preferred embodiments, the length of the tubular portion 4a is from about 15 mm to about 35 mm, more preferably from about 20 mm to about 30 mm, even more preferably from about 23 to about 27 mm, most preferably about 25 mm. In the present example, the length of the tubular portion 4a is 25 mm.

Preferably, the second plug wrap 9 has a basis weight of less than 50 gsm, more preferably between about 20 gsm and 45 gsm. However, it should be recognised that the basis weight of the second plug wrap 9 may be higher to increase the hardness of the mouthpiece. For instance, the basis weight of the second plug wrap 9 may be at least 50, 60, 70, 80, 90 or 100 gsm. In some embodiments, the basis weight of the second plug wrap 9 is in the range of 50 to 110 gsm, or in the range of 60 to 100 gsm.

In some embodiments, the second plug wrap 9 has a basis weight of at least 10 gsm or at least 15 gsm or at least 20 gsm or at least 25 gsm.

In some embodiments, the second plug wrap 9 has a basis weight of less than 40, less than 35 or less than 30 gsm.

In some embodiments, the second plug wrap 9 has a basis weight in the range of 10 to gsm and, preferably, in the range of 15 to 35 gsm, or in the range of 20 to 30 gsm, or in the range of 25 to 30 gsm. In some embodiments, the basis weight of the second plug wrap 9 is about 27 gsm.

Preferably, the second plug wrap 9 has a thickness of between 30 μm and 60 μm, more preferably between 35 μm and 45 μm. However, it should be recognised that the thickness weight of the second plug wrap 9 may be higher to increase the hardness of the mouthpiece. In some embodiments, for example, the thickness of the second plug wrap 9 may be at least 40, 50, 60, 70, 80, 90 or 100 microns. In some embodiments, the thickness of the second plug wrap 9 is in the range of 40 to 120 microns, or in the range of 50 to 100 microns.

The second plug wrap 9 is preferably a non-porous plug wrap having a permeability of less than 100 Coresta Units, for instance less than 50 Coresta Units. However, in alternative embodiments, the second plug wrap 9 can be a porous plug wrap, for instance having a permeability of greater than 200 Coresta Units.

The tubular portion 4a is located around and defines an air gap within the mouthpiece 2 which acts as a cooling segment. The air gap provides a chamber through which heated volatilised components generated by the aerosol generating material 3 flow. The tubular portion 4a is hollow to provide a chamber for aerosol accumulation yet rigid enough to withstand axial compressive forces and bending moments that might arise during manufacture and whilst the article 1 is in use. The tubular portion 4a provides a physical displacement between the aerosol generating material 3 and the body of material 6. The physical displacement provided by the tubular portion 4a will provide a thermal gradient across the length of the tubular portion 4a.

Preferably, the mouthpiece 2 comprises a cavity having an internal volume greater than 450 mm³. Providing a cavity of at least this volume has been found to enable the formation of an improved aerosol. Such a cavity size provides sufficient space within the mouthpiece 2 to allow heated volatilised components to cool, therefore allowing the exposure of the aerosol generating material 3 to higher temperatures than would otherwise be possible, since they may result in an aerosol which is too warm. In the present example, the cavity is formed by the tubular portion 4a, but in alternative arrangements it could be formed within a different part of the mouthpiece 2. More preferably, the mouthpiece 2 comprises a cavity, for instance formed within the tubular portion 4a, having an internal volume greater than 500 mm³, and still more preferably greater than 550 mm³, allowing further improvement of the aerosol. In some examples, the internal cavity comprises a volume of between about 550 mm³ and about 850 mm³ and, preferably, between about 600 mm³ and about 800 mm³ 7. In the present example, the internal cavity of the tubular portion 4a has a volume of about 762 mm³.

The tubular portion 4a can be configured to provide a temperature differential of at least 40 degrees Celsius between a heated volatilised component entering a first, upstream end of the tubular portion 4a and a heated volatilised component exiting a second, downstream end of the tubular portion 4a. The tubular portion 4a is preferably configured to provide a temperature differential of at least 60 degrees Celsius, preferably at least 80 degrees Celsius and more preferably at least 100 degrees Celsius between a heated volatilised component entering a first, upstream end of the tubular portion 4a and a heated volatilised component exiting a second, downstream end of the tubular portion 4a. This temperature differential across the length of the tubular portion 4a protects the temperature sensitive body of material 6 from the high temperatures of the aerosol generating material 3 when it is heated.

In alternative articles, the tubular portion 4a can be replaced with an alternative cooling element, for instance an element formed from a body of material which allows aerosol to pass through it longitudinally, and which also performs the function of cooling the aerosol.

The mouthpiece 2 of the article 1 comprises an upstream end 3a adjacent to the aerosol generating substrate 3 and a downstream end 2b distal from the aerosol generating substrate 3.

The pressure drop or difference (also referred to a resistance to draw) across the mouthpiece, for instance the part of the article 1 downstream of the aerosol generating material 3, is preferably less than about 40 mmH₂O. Such pressure drops have been found to allow sufficient aerosol, including desirable compounds such as flavour compounds, to pass through the mouthpiece 2 to the consumer. More preferably, the pressure drop across the mouthpiece 2 is less than about 20 mmH₂O. In some embodiments, particularly improved aerosol has been achieved using a mouthpiece 2 having a pressure drop of less than 15 mmH₂O, for instance about 6 mmH₂O, about 10 mmH₂O or about 14 mmH₂O. Alternatively or additionally, the mouthpiece pressure drop can be at least 3 mmH₂O, preferably at least 4 mmH₂O and more preferably at least 5 mmH₂O. In some embodiments, the mouthpiece pressure drop can be between about 5 mmH₂O and 20 mmH₂O and, preferably, between 5 mmH₂O and 15 mmH₂O.

These values enable the mouthpiece 2 to slow down the aerosol as it passes through the mouthpiece 2 such that the temperature of the aerosol has time to reduce before reaching the downstream end 2b of the mouthpiece 2.

In the present example, the aerosol generating material 3 is wrapped in a wrapper 10. The wrapper 10 can, for instance, be a paper or paper-backed foil wrapper. In the present example, the wrapper 10 is substantially impermeable to air. In alternative embodiments, the wrapper 10 preferably has a permeability of less than 100 Coresta Units, more preferably less than 60 Coresta Units. It has been found that low permeability wrappers, for instance having a permeability of less than 100 Coresta Units, more preferably less than 60 Coresta Units, results in an improvement in the aerosol formation in the aerosol generating material 3. Without wishing to be bound by theory, it is hypothesised that this is due to reduced loss of aerosol compounds through the wrapper 10. The permeability of the wrapper 10 can be measured in accordance with ISO 2965:2009 concerning the determination of air permeability for materials used as cigarette papers, filter plug wrap and filter joining paper.

In the present embodiment, the wrapper 10 comprises aluminium foil. Aluminium foil has been found to be particularly effective at enhancing the formation of aerosol within the aerosol generating material 3. In the present example, the aluminium foil has a metal layer having a thickness of about 6 μm. In the present example, the aluminium foil has a paper backing. However, in alternative arrangements, the aluminium foil can be other thicknesses, for instance between 4 μm and 16 μm in thickness. The aluminium foil also need not have a paper backing, but could have a backing formed from other materials, for instance to help provide an appropriate tensile strength to the foil, or it could have no backing material. Metallic layers or foils other than aluminium can also be used. The total thickness of the wrapper is preferably between 20 m and 60 μm, more preferably between 30 μm and 50 μm, which can provide a wrapper having appropriate structural integrity and heat transfer characteristics. The tensile force which can be applied to the wrapper before it breaks can be greater than 3,000 grams force, for instance between 3,000 and 10,000 grams force or between 3,000 and 4,500 grams force.

In some examples, the wrapper 10 surrounding the aerosol generating material 3 has a high level of permeability, for example greater than about 1000 Coresta Units, or greater than about 1500 Coresta Units, or greater than about 2000 Coresta Units. The permeability of the wrapper 10 can be measured in accordance with ISO 2965:2009 concerning the determination of air permeability for materials used as cigarette papers, filter plug wrap and filter joining paper.

The wrapper 10 may be formed from a material with a high inherent level of permeability, an inherently porous material, or may be formed from a material with any level of inherent permeability where the final level of permeability is achieved by providing the wrapper 10 with a permeable zone or area. Providing a permeable wrapper 10 provides a route for air to enter the article. The wrapper 10 can be provided with a permeability such that the amount of air entering through the rod of aerosol generating material is relatively more than the amount of air entering the article through the ventilation holes 12 in the mouthpiece. An article having this arrangement may produce a more flavoursome aerosol which may be more satisfactory to the user.

In the present example, the aerosol-former material added to the aerosol generating substrate 3 comprises 14% by weight of the aerosol generating substrate 3. Preferably, the aerosol-former material comprises at least 5% by weight of the aerosol generating substrate, more preferably at least 10%. Preferably, the aerosol-former material comprises less than 25% by weight of the aerosol generating substrate, more preferably less than 20%, for instance between 10% and 20%, between 12% and 18% or between 13% and 16%.

Preferably the aerosol generating material 3 is provided as a cylindrical rod of aerosol generating material. Irrespective of the form of the aerosol generating material, it preferably has a length of about 10 mm to 100 mm. In some embodiments, the length of the aerosol generating material is preferably in the range about 25 mm to 50 mm, more preferably in the range about 30 mm to 45 mm, and still more preferably about 30 mm to 40 mm.

In some examples, the article 1 may be configured such that there is a separation (i.e. a minimum distance) between a heater of the non-combustible aerosol provision device 100 and the tubular body 4a. This prevents heat from the heater from damaging the material forming the tubular body 4a.

The minimum distance between a heater of the non-combustible aerosol provision device 100 and the tubular body 4a may be 3 mm or greater. In some examples, minimum distance between the heater of the non-combustible aerosol provision device 100 and the tubular body 4a may be in the range 3 mm to 10 mm, for example 3 mm, 4 mm, 5 mm, 6 mm, 7 mm, 8 mm, 9 mm or 10 mm.

The separation between the heater of the non-combustible aerosol provision device 100 and the tubular body 4a may be achieved by, for example, adjusting the length of the rod of aerosol generating material 3.

The volume of aerosol generating material 3 provided can vary from about 200 mm³ to about 4300 mm³, preferably from about 500 mm³ to 1500 mm³, more preferably from about 1000 mm³ to about 1300 mm³. The provision of these volumes of aerosol generating material, for instance from about 1000 mm³ to about 1300 mm³, has been advantageously shown to achieve a superior aerosol, having a greater visibility and sensory performance compared to that achieved with volumes selected from the lower end of the range.

The mass of aerosol generating material 3 provided can be greater than 200 mg, for instance from about 200 mg to 400 mg, preferably from about 230 mg to 360 mg, more preferably from about 250 mg to 360 mg. It has been advantageously found that providing a higher mass of aerosol generating material results in improved sensory performance compared to aerosol generated from a lower mass of tobacco material.

Preferably the aerosol generating material or substrate is formed from tobacco material as described herein, which includes a tobacco component.

In the tobacco material described herein, the tobacco component preferably contains paper reconstituted tobacco. The tobacco component may also contain leaf tobacco, extruded tobacco, and/or bandcast tobacco.

The aerosol generating material 3 can comprise reconstituted tobacco material having a density of less than about 700 milligrams per cubic centimetre (mg/cc). Such tobacco material has been found to be particularly effective at providing an aerosol generating material which can be heated quickly to release an aerosol, as compared to denser materials. For instance, the inventors tested the properties of various aerosol generating materials, such as bandcast reconstituted tobacco material and paper reconstituted tobacco material, when heated. It was found that, for each given aerosol generating material, there is a particular zero heat flow temperature below which net heat flow is endothermic, in other words more heat enters the material than leaves the material, and above which net heat flow is exothermic, in other words more heat leaves the material than enters the material, while heat is applied to the material. Materials having a density less than 700 mg/cc had a lower zero heat flow temperature. Since a significant portion of the heat flow out of the material is via the formation of aerosol, having a lower zero heat flow temperature has a beneficial effect on the time it takes to first release aerosol from the aerosol generating material. For instance, aerosol generating materials having a density of less than 700 mg/cc were found to have a zero heat flow temperature of less than 164° C., as compared to materials with a density over 700 mg/cc, which had zero heat flow temperatures greater than 164° C.

The density of the aerosol generating material also has an impact on the speed at which heat conducts through the material, with lower densities, for instance those below 700 mg/cc, conducting heat more slowly through the material, and therefore enabling a more sustained release of aerosol.

Preferably, the aerosol generating material 3 comprises reconstituted tobacco material having a density of less than about 700 mg/cc, for instance paper reconstituted tobacco material. More preferably, the aerosol generating material 3 comprises reconstituted tobacco material having a density of less than about 600 mg/cc. Alternatively or in addition, the aerosol generating material 3 preferably comprises reconstituted tobacco material having a density of at least 350 mg/cc, which is considered to allow for a sufficient amount of heat conduction through the material.

The tobacco material may be provided in the form of cut rag tobacco. The cut rag tobacco can have a cut width of at least 15 cuts per inch (about 5.9 cuts per cm, equivalent to a cut width of about 1.7 mm). Preferably, the cut rag tobacco has a cut width of at least 18 cuts per inch (about 7.1 cuts per cm, equivalent to a cut width of about 1.4 mm), more preferably at least 20 cuts per inch (about 7.9 cuts per cm, equivalent to a cut width of about 1.27 mm). In one example, the cut rag tobacco has a cut width of 22 cuts per inch (about 8.7 cuts per cm, equivalent to a cut width of about 1.15 mm). Preferably, the cut rag tobacco has a cut width at or below 40 cuts per inch (about 15.7 cuts per cm, equivalent to a cut width of about 0.64 mm). Cut widths between 0.5 mm and 2.0 mm, for instance between 0.6 mm and 1.5 mm, or between 0.6 mm and 1.7 mm have been found to result in tobacco material which is preferably in terms of surface area to volume ratio, particularly when heated, and the overall density and pressure drop of the substrate 3. The cut rag tobacco can be formed from a mixture of forms of tobacco material, for instance a mixture of one or more of paper reconstituted tobacco, leaf tobacco, extruded tobacco and bandcast tobacco. Preferably the tobacco material comprises paper reconstituted tobacco or a mixture of paper reconstituted tobacco and leaf tobacco.

In the tobacco material described herein, the tobacco material may contain a filler component. The filler component is generally a non-tobacco component, that is, a component that does not include ingredients originating from tobacco. The filler component may be a non-tobacco fibre such as wood fibre or pulp or wheat fibre. The filler component may also be an inorganic material such as chalk, perlite, vermiculite, diatomaceous earth, colloidal silica, magnesium oxide, magnesium sulphate, magnesium carbonate. The filler component may also be a non-tobacco cast material or a non-tobacco extruded material. The filler component may be present in an amount of 0 to 20% by weight of the tobacco material, or in an amount of from 1 to 10% by weight of the composition. In some embodiments, the filler component is absent.

In the tobacco material described herein, the tobacco material contains an aerosol-former material. In this context, an “aerosol-former material” is an agent that promotes the generation of an aerosol. An aerosol-former material may promote the generation of an aerosol by promoting an initial vaporisation and/or the condensation of a gas to an inhalable solid and/or liquid aerosol. In some embodiments, an aerosol-former material may improve the delivery of flavour from the aerosol generating material. In general, any suitable aerosol-former material or agents may be included in the aerosol generating material of the invention, including those described herein. Other suitable aerosol-former materials include, but are not limited to: a polyol such as sorbitol, glycerol, and glycols like propylene glycol or triethylene glycol; a non-polyol such as monohydric alcohols, high boiling point hydrocarbons, acids such as lactic acid, glycerol derivatives, esters such as diacetin, triacetin, triethylene glycol diacetate, triethyl citrate or myristates including ethyl myristate and isopropyl myristate and aliphatic carboxylic acid esters such as methyl stearate, dimethyl dodecanedioate and dimethyl tetradecanedioate. In some embodiments, the aerosol-former material may be glycerol, propylene glycol, or a mixture of glycerol and propylene glycol. Glycerol may be present in an amount of from 10 to 20% by weight of the tobacco material, for example 13 to 16% by weight of the composition, or about 14% or 15% by weight of the composition. Propylene glycol, if present, may be present in an amount of from 0.1 to 0.3% by weight of the composition.

The aerosol-former material may be included in any component, for example any tobacco component, of the tobacco material, and/or in the filler component, if present. Alternatively or additionally the aerosol-former material may be added to the tobacco material separately. In either case, the total amount of the aerosol-former material in the tobacco material can be as defined herein.

The tobacco material can contain between 10% and 90% by weight tobacco leaf, wherein the aerosol-former material is provided in an amount of up to about 10% by weight of the leaf tobacco. To achieve an overall level of aerosol-former material between 10% and 20% by weight of the tobacco material, it has been advantageously found that this can be added in higher weight percentages to the another component of the tobacco material, such as reconstituted tobacco material.

The tobacco material described herein contains nicotine. The nicotine content is from 0.5 to 1.75% by weight of the tobacco material, and may be, for example, from 0.8 to 1.5% by weight of the tobacco material. Additionally or alternatively, the tobacco material contains between 10% and 90% by weight tobacco leaf having a nicotine content of greater than 1.5% by weight of the tobacco leaf. It has been advantageously found that using a tobacco leaf with nicotine content higher than 1.5% in combination with a lower nicotine base material, such as paper reconstituted tobacco, provides a tobacco material with an appropriate nicotine level but better sensory performance than the use of paper reconstituted tobacco alone. The tobacco leaf, for instance cut rag tobacco, can, for instance, have a nicotine content of between 1.5% and 5% by weight of the tobacco leaf.

The tobacco material described herein can contain an aerosol modifying agent, such as any of the flavours described herein. In one embodiment, the tobacco material contains menthol, forming a mentholated article. The tobacco material can comprise from 3 mg to 20 mg of menthol, preferably between 5 mg and 18 mg and more preferably between 8 mg and 16 mg of menthol. In the present example, the tobacco material comprises 16 mg of menthol. The tobacco material can contain between 2% and 8% by weight of menthol, preferably between 3% and 7% by weight of menthol and more preferably between 4% and 5.5% by weight of menthol. In one embodiment, the tobacco material includes 4.7% by weight of menthol. Such high levels of menthol loading can be achieved using a high percentage of reconstituted tobacco material, for instance greater than 50% of the tobacco material by weight. Alternatively or additionally, the use of a high volume of aerosol generating material, for instance tobacco material, can increase the level of menthol loading that can be achieved, for instance where greater than about 500 mm³ or suitably more than about 1000 mm³ of aerosol generating material, such as tobacco material, are used.

In the compositions described herein, where amounts are given in % by weight, for the avoidance of doubt this refers to a dry weight basis, unless specifically indicated to the contrary. Thus, any water that may be present in the tobacco material, or in any component thereof, is entirely disregarded for the purposes of the determination of the weight %. The water content of the tobacco material described herein may vary and may be, for example, from 5 to 15% by weight. The water content of the tobacco material described herein may vary according to, for example, the temperature, pressure and humidity conditions at which the compositions are maintained. The water content can be determined by Karl-Fisher analysis, as known to those skilled in the art. On the other hand, for the avoidance of doubt, even when the aerosol-former material is a component that is in liquid phase, such as glycerol or propylene glycol, any component other than water is included in the weight of the tobacco material. However, when the aerosol-former material is provided in the tobacco component of the tobacco material, or in the filler component (if present) of the tobacco material, instead of or in addition to being added separately to the tobacco material, the aerosol-former material is not included in the weight of the tobacco component or filler component, but is included in the weight of the “aerosol-former material” in the weight % as defined herein. All other ingredients present in the tobacco component are included in the weight of the tobacco component, even if of non-tobacco origin (for example non-tobacco fibres in the case of paper reconstituted tobacco).

In an embodiment, the tobacco material comprises the tobacco component as defined herein and the aerosol-former material as defined herein. In an embodiment, the tobacco material consists essentially of the tobacco component as defined herein and the aerosol-former material as defined herein. In an embodiment, the tobacco material consists of the tobacco component as defined herein and the aerosol-former material as defined herein.

Paper reconstituted tobacco is present in the tobacco component of the tobacco material described herein in an amount of from 10% to 100% by weight of the tobacco component. In embodiments, the paper reconstituted tobacco is present in an amount of from 10% to 80% by weight, or 20% to 70% by weight, of the tobacco component. In a further embodiment, the tobacco component consists essentially of, or consists of, paper reconstituted tobacco. In preferred embodiments, leaf tobacco is present in the tobacco component of the tobacco material in an amount of from at least 10% by weight of the tobacco component. For instance, leaf tobacco can be present in an amount of at least 10% by weight of the tobacco component, while the remainder of the tobacco component comprises paper reconstituted tobacco, bandcast reconstituted tobacco, or a combination of bandcast reconstituted tobacco and another form of tobacco such as tobacco granules.

Paper reconstituted tobacco refers to tobacco material formed by a process in which tobacco feedstock is extracted with a solvent to afford an extract of solubles and a residue comprising fibrous material, and then the extract (usually after concentration, and optionally after further processing) is recombined with fibrous material from the residue (usually after refining of the fibrous material, and optionally with the addition of a portion of non-tobacco fibres) by deposition of the extract onto the fibrous material. The process of recombination resembles the process for making paper.

The paper reconstituted tobacco may be any type of paper reconstituted tobacco that is known in the art. In a particular embodiment, the paper reconstituted tobacco is made from a feedstock comprising one or more of tobacco strips, tobacco stems, and whole leaf tobacco. In a further embodiment, the paper reconstituted tobacco is made from a feedstock consisting of tobacco strips and/or whole leaf tobacco, and tobacco stems. However, in other embodiments, scraps, fines and winnowings can alternatively or additionally be employed in the feedstock.

The paper reconstituted tobacco for use in the tobacco material described herein may be prepared by methods which are known to those skilled in the art for preparing paper reconstituted tobacco.

In some embodiments, it can be particularly advantageous to use a hollow tubular element 8 having a length of greater than about 10 mm, for instance between about 10 mm and about 30 mm or between about 12 mm and about 25 mm. It has been found that a consumer's lips are likely to extend in some cases to about 12 mm from the mouth end of the article 1 when drawing aerosol through the article 1, and therefore a hollow tubular element 8 having a length of at least 10 mm or at least 12 mm means that most of the consumer's lips surround this element 8.

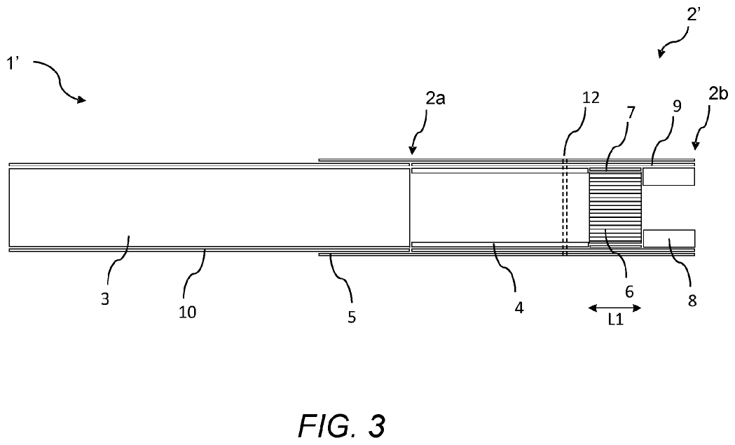

FIG. 3 is a side-on cross sectional view of a further article 1′, including mouthpiece 2′ including a hollow tubular element 8. Mouthpiece 2′ is substantially the same as mouthpiece 2 described above, except that at the downstream end 2b, the mouthpiece 2′ has a hollow tubular element 8 formed from filamentary tow. In the present example the tubular portion 4a, body of material 6 and hollow tubular element 8 are combined using the second plug wrap 9 which is wrapped around all three sections.

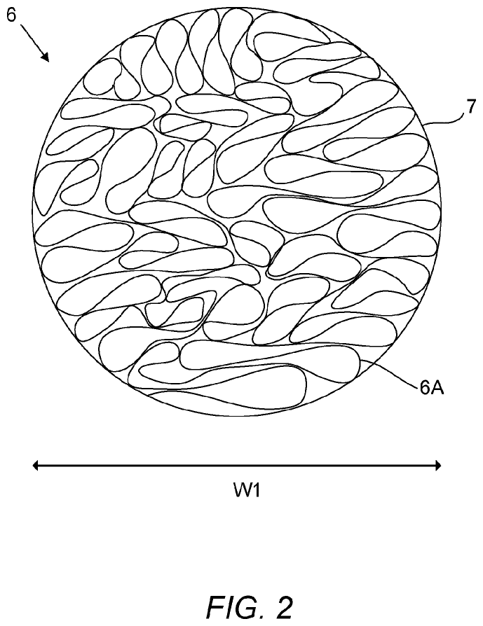

The body of material 6 of the article 1′ of FIG. 3 is similar to the body of material 6 described above in relation to FIGS. 1 and 2. As before, the body of material 6 is manufactured from a sheet material comprising cellulose, for example, the sheet material may be paper. The sheet material is gathered to form the body of material 6. The body of material 6 has an outer volume of at least 115 mm³.

In the present example, the axial length L1 of the body of material 6 is about 10 mm. However, a skilled person will recognise that the body of material 6 may have a different axial length L1. Preferably, the length L1 of the body of material 6 is less than about 20 mm and, preferably, less than 15 mm. More preferably, the length L1 of the body of material 6 is less than about 10 mm. In addition, or as an alternative, the length L1 of the body of material 6 is at least about 5 mm. Preferably, the length L1 of the body of material 6 is at least about 6 mm. In some preferred embodiments, the length L1 of the body of material 6 is from about 5 mm to about 15 mm, more preferably from about 6 mm to about 12 mm, even more preferably from about 6 mm to about 12 mm, most preferably about 6 mm, 7 mm, 8 mm, 9 mm or 10 mm.

The part of the mouthpiece which comes into contact with a consumer's lips has usually been a paper tube, which is either hollow or surrounds a cylindrical body of filter material. Providing a hollow tubular element 8 has advantageously been found to significantly reduce the temperature of the outer surface of the mouthpiece 2′ at the downstream end 2b of the mouthpiece which comes into contact with a consumer's mouth when the article 1′ is in use. In addition, the use of the tubular portion 4a has also been found to significantly reduce the temperature of the outer surface of the mouthpiece 2′ even upstream of the tubular portion 4a. Without wishing to be bound by theory, it is hypothesised that this is due to the tubular portion 4a channelling aerosol closer to the centre of the mouthpiece 2′, and therefore reducing the transfer of heat from the aerosol to the outer surface of the mouthpiece 2′. In addition, the body of material 6 has been found to remove moisture from aerosol generated by the aerosol generating material 3 as the aerosol passes through the body of material 6A of the mouthpiece 2, which makes the aerosol feel cooler in the user's mouth.

In the present example hollow tubular element 8 is formed from filamentary tow. In alternative embodiments the hollow tubular element may be formed using any construction as described herein for the tubular portion 4a.

The “wall thickness” of the hollow tubular element 8 corresponds to the thickness of the wall of the tube 8 in a radial direction. This may be measured in the same way as that of the tubular portion. The wall thickness is advantageously greater than 0.9 mm, and more preferably 1.0 mm or greater. Preferably, the wall thickness is substantially constant around the entire wall of the hollow tubular element 8. However, where the wall thickness is not substantially constant, the wall thickness is preferably greater than 0.9 mm at any point around the hollow tubular element 8, more preferably 1.0 mm or greater.

Preferably, the length of the hollow tubular element 8 is less than about 20 mm. More preferably, the length of the hollow tubular element 8 is less than about 15 mm. Still more preferably, the length of the hollow tubular element 8 is less than about 10 mm. In addition, or as an alternative, the length of the hollow tubular element 8 is at least about 5 mm. Preferably, the length of the hollow tubular element 8 is at least about 6 mm. In some preferred embodiments, the length of the hollow tubular element 8 is from about 5 mm to about 20 mm, more preferably from about 6 mm to about 10 mm, even more preferably from about 6 mm to about 8 mm, most preferably about 6 mm, 7 mm or about 8 mm. In the present example, the length of the hollow tubular element 8 is 6 mm.

Preferably, the density of the hollow tubular element 8 is at least about 0.25 grams per cubic centimetre (g/cc), more preferably at least about 0.3 g/cc. Preferably, the density of the hollow tubular element 8 is less than about 0.75 grams per cubic centimetre (g/cc), more preferably less than 0.6 g/cc. In some embodiments, the density of the hollow tubular element 8 is between 0.25 and 0.75 g/cc, more preferably between 0.3 and 0.6 g/cc, and more preferably between 0.4 g/cc and 0.6 g/cc or about 0.5 g/cc. These densities have been found to provide a good balance between improved firmness afforded by denser material and the lower heat transfer properties of lower density material. For the purposes of the present invention, the “density” of the hollow tubular element 8 refers to the density of the filamentary tow forming the element with any plasticiser incorporated. The density may be determined by dividing the total weight of the hollow tubular element 8 by the total volume of the hollow tubular element 8, wherein the total volume can be calculated using appropriate measurements of the hollow tubular element 8 taken, for example, using calipers. Where necessary, the appropriate dimensions may be measured using a microscope.

The filamentary tow forming the hollow tubular element 8 preferably has a total denier of less than 45,000, more preferably less than 42,000. This total denier has been found to allow the formation of a hollow tubular element 8 which is not too dense. Preferably, the total denier is at least 20,000, more preferably at least 25,000. In preferred embodiments, the filamentary tow forming the hollow tubular element 8 has a total denier between 25,000 and 45,000, more preferably between 35,000 and 45,000. Preferably the cross-sectional shape of the filaments of tow are ‘Y’ shaped, although in other embodiments other shapes such as ‘X’ shaped filaments can be used.

The filamentary tow forming the hollow tubular element 8 preferably has a denier per filament of greater than 3. This denier per filament has been found to allow the formation of a hollow tubular element 8 which is not too dense. Preferably, the denier per filament is at least 4, more preferably at least 5. In preferred embodiments, the filamentary tow forming the hollow tubular element 8 has a denier per filament between 4 and 10, more preferably between 4 and 9. In one example, the filamentary tow forming the hollow tubular element 8 has an 8Y40,000 tow formed from cellulose acetate and comprising 18% plasticiser, for instance triacetin.

The hollow tubular element 8 preferably has an internal diameter of greater than 3.0 mm. Smaller diameters than this can result in increasing the velocity of aerosol passing though the mouthpiece 2′ to the consumers mouth more than is desirable, such that the aerosol becomes too warm, for instance reaching temperatures greater than 40° C. or greater than 45° C. More preferably, the hollow tubular element 8 has an internal diameter of greater than 3.1 mm, and still more preferably greater than 3.5 mm or 3.6 mm. In one embodiment, the internal diameter of the hollow tubular element 8 is about 3.9 mm.

The hollow tubular element 8 preferably comprises from 15% to 22% by weight of plasticiser. For cellulose acetate tow, the plasticiser is preferably triacetin, although other plasticisers such as polyethylene glycol (PEG) can be used. More preferably, the hollow tubular element 8 comprises from 16% to 20% by weight of plasticiser, for instance about 17%, about 18% or about 19% plasticiser.

In the present example the tubular portion 4a is a first hollow tubular element, and hollow tubular element 8 is a second hollow tubular element.

In the present example the ventilation is provided into tubular portion 4a, as described in relation to FIG. 1. In alternative embodiments, the ventilation can be provided into the mouthpiece at other locations, for instance into the body of material 6 or hollow tubular element 8.

In the examples described above, the mouthpieces 2, 2′ each comprise a single body of material 6. In other examples, the mouthpiece 2, 2′ may include multiple bodies of material. The mouthpieces 2, 2′ may comprise a cavity between the bodies of material.

In some examples, the mouthpiece 2, 2′ downstream of the aerosol generating material 3 can comprise a wrapper, for instance the first or second plug wraps 7, 9, or tipping paper 5, which comprises an aerosol modifying agent as described herein or other sensate material. The aerosol modifying agent may be disposed on an inwardly or outwardly facing surface of the mouthpiece wrapper. For instance, the aerosol modifying agent or other sensate material may be provided on an area of the wrapper, such as an outwardly facing surface of the tipping paper 5, which comes into contact with the consumer's lips during use. By disposing the aerosol modifying agent or other sensate material on the outwardly facing surface of the mouthpiece wrapper, the aerosol modifying agent or other sensate material may be transferred to the consumer's lips during use. Transfer of the aerosol modifying agent or other sensate material to the consumer's lips during use of the article may modify the organoleptic properties (e.g. taste) of the aerosol generated by the aerosol generating substrate 3 or otherwise provide the consumer with an alternative sensory experience. For example, the aerosol modifying agent or other sensate material may impart flavour to the aerosol generated by the aerosol generating substrate 3. The aerosol modifying agent or other sensate material may be at least partially soluble in water such that it is transferred to the user via the consumer's saliva. The aerosol modifying agent or other sensate material may be one that volatilises by the heat generated by the aerosol provision system. This may facilitate transfer of the aerosol modifying agent to the aerosol generated by the aerosol generating substrate 3. A suitable sensate material may be a flavour as described herein, sucralose or a cooling agent such as menthol or similar. In other embodiments (not shown), the mouthpiece 2, 2′ additionally or alternatively comprises an aerosol-modifying agent release component, that is operable to selectively release the aerosol-modifying agent.

The aerosol-modifying agent may, for example, be an additive or a sorbent. The aerosol-modifying agent may, for example, comprise one or more of a flavourant, a colourant, water, and a carbon adsorbent. The aerosol-modifying agent may, for example, be a solid, a liquid, or a gel. The aerosol-modifying agent may be in powder, thread or granule form. The aerosol-modifying agent may be free from filtration material.

The aerosol-modifying agent release component may be, for example, a capsule, thread or bead. In some embodiments, a plurality of aerosol-modifying agent release components are provided, and may comprise a plurality of charcoal particles loaded with aerosol-modifying agent.

In some embodiments, the aerosol-modifying agent release component comprises a thread loaded with additive. The thread may made from fibres of, for example, cellulose acetate or cotton.

In some embodiments, the aerosol-modifying release agent has in the range of 1 mg to 20 mg of aerosol-modifying agent and, preferably, in the range of 2 mg to 15 mg of aerosol-modifying agent.

The aerosol-modifying agent release component, for example, a capsule, may be located in the body 6. The or each aerosol-modifying agent release component may be combined with the sheet material 6A, for instance, being adhered thereto, before the sheet material 6A is formed into the body 6.

In some embodiments, a non-combustible aerosol provision system is provided comprising an aerosol-modifying agent release component and a heater which, in use, is operable to heat the aerosol generating material 3 such that the aerosol generating material 3 provides an aerosol.

The aerosol-modifying agent release component may comprise a capsule. In some embodiments, the aerosol-modifying agent release component comprises first and second capsules. The first capsule is disposed in a first portion of the aerosol-modifying agent release component and the second capsule is disposed in a second portion of the aerosol-modifying agent release component downstream of the first portion.

The first portion of the aerosol-modifying agent release component is heated to a first temperature during operation of the heater to generate the aerosol and the second portion is heated to a second temperature during operation of the heater to generate aerosol, wherein the second temperature is at least 4 degrees Celsius lower than the first temperature. Preferably, the second temperature is at least 5, 6, 7, 8, 9 or 10 degrees Celsius lower than the first temperature.

The aerosol-modifying agent release component may comprise one or more components of the article 1. In some embodiments, the first and second capsules are disposed in the body of material 6. In one embodiment, the aerosol-modifying agent release component comprises two bodies of material (not shown), wherein the first and second capsules are disposed in the first and second bodies respectively. In some embodiments, the aerosol-modifying agent release component alternatively or additionally comprises one or more tubular elements upstream and/or downstream of the body or bodies of material. The aerosol generating component may comprise the mouthpiece 2, 2′.

In some embodiments, the second capsule is spaced from the first capsule by a distance of at least 7 mm, measured as the distance between the centre of the first and second capsules. Preferably, the second capsule is spaced from the first capsule by a distance of at least 8, 9 or 10 mm. It has been found that increasing the distance between the first and second capsules increases the difference between the first and second temperatures.

The first capsule comprises an aerosol modifying agent. The second capsule comprises an aerosol modifying agent which may be the same or different as the aerosol modifying agent of the first capsule. In some embodiments, a user may selectively rupture the first and second capsules by applying an external force to the aerosol-modifying agent release component in order to release the aerosol modifying agent from each capsule.

The aerosol-modifying agent of the second capsule is heated to a lower temperature than the aerosol-modifying agent of the first capsule due to the difference between the first and second temperatures.

The aerosol-modifying agents of the first and second capsules can be selected based on this temperature difference. For instance, the first capsule may comprise a first aerosol modifying agent that has a lower vapour pressure than a second aerosol modifying agent of the second capsule. If the capsules were both heated to the same temperature, then the higher vapour pressure of the aerosol modifying agent of the second capsule would mean that a greater amount of the second aerosol modifying agent would be volatised relative to the aerosol modifying agent of the first capsule. However, since the second capsule is heated to a lower temperature, this effect is less pronounced such that a more even amount of the aerosol modifying agents of the first and second capsules are volatised upon breaking of the first and second capsules respectively.

In some embodiments, the first and second capsules have the same aerosol-modifying profiles, meaning that both capsules contain the same type of aerosol-modifying agent and in the same amount such that if both capsules were heated to the same temperature and broken then both capsules would cause the same modification of the aerosol. However, since the first capsule is heated to a higher temperature than the second capsule, more of the aerosol-modifying agent of the first capsule will be, for example, volatised compared to the modifying agent of the second capsule and thus will cause a more pronounced modification of the aerosol than the second capsule. Therefore, despite both capsules being the same, which may make the aerosol-modifying agent release component easier and/or less expensive to manufacture, the user can decide whether to break the first capsule to cause a more pronounced modification of the aerosol, or the second capsule to cause a less pronounced modification of the aerosol, or both capsules to cause the greatest modification of the aerosol.

In some embodiments, the first and second capsules both comprise first and second aerosol modifying agents. The first aerosol modifying agent has a lower vapour pressure than the second aerosol modifying agent. Thus, when the second capsule is broken, a greater proportion of the second aerosol modifying agent will be vaporised relative to the first aerosol modifying agent in comparison to when the hotter first capsule is broken during use of the system to generate aerosol. Therefore, the same capsule can be used to generate different modifications of the aerosol based on the positon of the capsule in the first or second portion of the aerosol-modifying agent release component.

In some embodiments, the or each capsule comprises an outer shell and an inner core.

The shell of each capsule may be solid at room temperature. The shell may comprise, consist of, or essentially consist of, alginate. However, it should be recognised that in alternative embodiments the shell is formed from a different material. For example, the shell may alternatively comprise, consist of, or essentially consist of, gelatin, carrageenans or pectins. The shell may comprise, consist of, or essentially consist of, one or more of alginate, gelatin, carrageenans or pectins.

The shell of each additive capsule may be impermeable, or substantially impermeable, to the aerosol modifying agent of the core. Therefore, the shell initially prevents the agent of the core from escaping from the capsule. When the user desires to modify the aerosol, the shells of the capsules are ruptured such that the agent is released.

In some embodiments (not shown), the or each capsule further comprises a carrier material. The carrier material may comprise, for example, gelatin.

In some embodiments, the or each capsule has a diameter in the range of 1 to 5 mm and, preferably, in the range of 2 to 4 mm. In some embodiments, the diameter of the or each capsule is about 3 mm. The or each capsule may be generally spherical. In other examples, other shapes and sizes of capsule can be used.

The total weight of each capsule may be in the range about 5 mg to about 50 mg and, preferably, in the range of about 10 to 30 mg. In some embodiments, each capsule has a weight of about 14 mg.

In some embodiments, one or more aerosol-modifying agent release components are included in the body of material 6, wherein the body of material 6 is formed from a sheet material having a basis weight of less than 40 gsm and, preferably, less than 35 or gsm. This helps to reduce the density of the body of material 6 to compensate for the presence of the aerosol-modifying agent release component within the body 6 which may otherwise result in an increase in the firmness of the body 6.

In some embodiments, one or more aerosol-modifying agent release components are included in the body of material 6, wherein the body of material 6 is formed from a sheet material having width of less than 100 mm and, preferably, less than 90 or 80 mm. This helps to reduce the density of the body of material 6 to compensate for the presence of the aerosol-modifying agent release component within the body 6 which may otherwise result in an increase in the firmness of the body 6.

In some embodiments, the or each capsule centred on the longitudinal axis of the mouthpiece 2.

As discussed above, each capsule may have a core-shell structure. That is, the encapsulating material or barrier material creates a shell around a core that comprises the aerosol modifying agent. The shell structure hinders migration of the aerosol modifying agent during storage of the article but allows controlled release of the aerosol modifying agent, also referred to as an aerosol modifier, during use.

In some cases, the barrier material (also referred to herein as the encapsulating material) is frangible. The or each capsule is crushed or otherwise fractured or broken by the user to release the encapsulated aerosol modifier. Typically, one or more of the capsules is broken immediately prior to heating being initiated but the user can select when to release the aerosol modifier of said capsule. The user can then choose to break the other capsules a later time, for example, after heating being initiated. The user may choose to break said other one of the capsules once some of the aerosol has been released from the aerosol generating material, such that the remaining aerosol generating material is modified by the aerosol modifying agent of another of the capsules. Alternatively, the user may choose to break a plurality of capsules simultaneously.

The term “breakable capsule” refers to a capsule, wherein the shell can be broken by means of a pressure to release the core; more specifically the shell can be ruptured under the pressure imposed by the user's fingers when the user wants to release the core of the capsule.

In some cases, the barrier material is heat resistant. That is to say, in some cases, the barrier will not rupture, melt or otherwise fail at the temperature reached at the capsule site during operation of the aerosol provision device. Illustratively, a capsule located in a mouthpiece may be exposed to temperatures in the range of 30° C. to 100° C. for example, and the barrier material may continue to retain the liquid core up to at least about 50° C. to 120° C.

In other cases, the or each capsule releases the core composition on heating, for example by melting of the barrier material or by capsule swelling leading to rupture of the barrier material.

The total weight of each capsule may be in the range of about 1 mg to about 100 mg, suitably about 5 mg to about 60 mg, about 8 mg to about 50 mg, about 10 mg to about 20 mg, or about 12 mg to about 18 mg.

The total weight of the core formulation may be in the range of about 2 mg to about 90 mg, suitably about 3 mg to about 70 mg, about 5 mg to about 25 mg, about 8 mg to about 20 mg, or about 10 mg to about 15 mg.

In some embodiments, the or each capsule comprises a core as described above, and a shell. The capsules may each present a crush strength from about 4.5 N to about 40 N, more preferably from about 5 N to about 30 N or to about 28 N (for instance about 9.8 N to about 24.5 N). The capsule burst strength of each capsule can be measured when said capsule is removed from the body of material 6 and using a force gauge to measure the force at which the capsule bursts when pressed between two flat metal plates. A suitable measurement device is the Sauter FK 50 force gauge with a flat headed attachment, which can be used to crush the capsule against a flat, hard surface having a surface similar to the attachment.

The or each capsule may be substantially spherical and have a diameter of at least about 0.4 mm, 0.6 mm, 0.8 mm, 1.0 mm, 2.0 mm, 2.5 mm, 2.8 mm or 3.0 mm. The diameter of the or each capsule may be less than about 10.0 mm, 8.0 mm, 7.0 mm, 6.0 mm, 5.5 mm, 5.0 mm, 4.5 mm, 4.0 mm, 3.5 mm or 3.2 mm. Illustratively, the capsule diameter may be in the range of about 0.4 mm to about 10.0 mm, about 0.8 mm to about 6.0 mm, about 2.5 mm to about 5.5 mm or about 2.8 mm to about 3.2 mm. In some cases, each capsule may have a diameter of about 3.0 mm. These sizes are particularly suitable for incorporation of the capsules into an article as described herein.

The cross-sectional area of each capsule at its largest cross sectional area is in some embodiments less than 28% of the cross sectional area of the portion of the mouthpiece 2 in which the capsule is provided, more preferably less than 27% and still more preferably less than 25%. For instance, for a spherical capsule having a diameter of 3.0 mm, the largest cross sectional area of the capsule is 7.07 mm². For the mouthpiece having a circumference of 21 mm as described herein, the body of material 6 has an outer circumference of 20.8 mm, and the radius of this component will be 3.31 mm, corresponding to a cross sectional area of 34.43 mm². The capsule cross sectional area is, in this example, 20.5% of the cross-sectional area of the mouthpiece 2. As another example, if a capsule had a diameter of 3.2 mm, its largest cross sectional area would be 8.04 mm². In this case, the cross sectional area of the capsule would be 23.4% of the cross sectional area of the body of material 6. A capsule with a largest cross sectional area less than 28% of the cross sectional area of the portion of the mouthpiece 2 in which the capsule is provided has the advantage that the pressure drop across the mouthpiece 2 is reduced as compared to capsules with larger cross sectional areas and adequate space remains around the capsule for aerosol to pass without the body of material 6 removing significant amounts of the aerosol mass as it passes through the mouthpiece 2. In some embodiments, first and second capsules are provided, which may be the same size or different sizes.

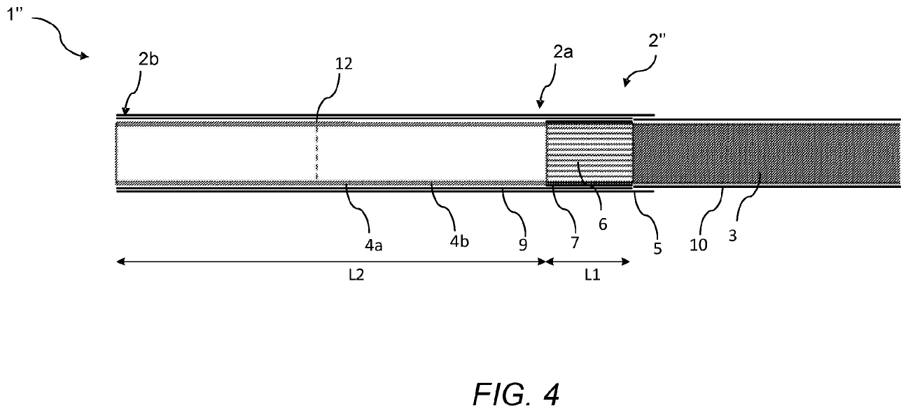

FIG. 4 is a side-on cross sectional view of a further article 1″, including mouthpiece 2″. Mouthpiece 2″ is substantially the same as mouthpiece 2 described above in relation to FIGS. 1 and 2. A difference is that the body of material 6 of the article 1″ is located upstream of the tubular portion 4a.

In the present example the tubular portion 4a and body of material 6 are combined using the second plug wrap 9 which is wrapped around both sections.

The body of material 6 of the article 1″ of FIG. 4 is similar to the body of material 6 described above in relation to FIGS. 1 to 3. As before, the body of material 6 is manufactured from a sheet material comprising cellulose, for example, the sheet material may be paper. The sheet material is gathered to form the body of material 6. The body of material 6 has an outer volume of at least 115 mm³.

The body of material 6 is disposed at the upstream end 2a of the mouthpiece 2′. The body of material 6 is adjacent to the aerosol generating material 3.

The tubular portion 4a is disposed at the downstream end 2b of the mouthpiece 2″ and thus forms a cavity 4c at the downstream end 2b. The tubular portion 4a is located downstream of the body of material 6. In the present example, the tubular portion 4a is adjacent to the body of material 6.

The tubular portion 4a has an axial length L2 of at least 20 mm and, preferably, at least 22 mm. In the present example, the axial length L2 of the tubular portion 4a is about 25 mm.

It has been found that the tube having an axial length L2 of at least 20 mm results in significant cooling of the aerosol as it passes through the tubular portion 4a. In addition, as explained previously, the cellulose containing sheet material of the body of material 6 absorbs water from the aerosol. Removing moisture from the aerosol makes the aerosol feel cooler in the user's mouth.

In some embodiments, the tubular portion 4a comprises one or more ventilation holes, which also contribute to cooling of the aerosol.

In some embodiments, the tubular portion 4a is manufactured from paper.

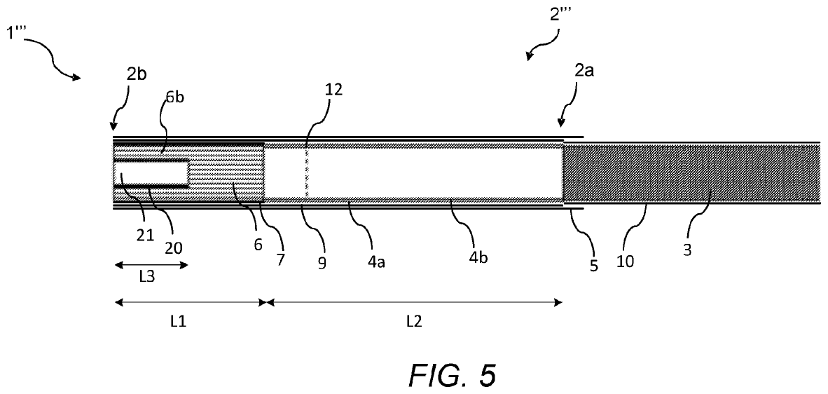

FIG. 5 is a side-on cross sectional view of a further article 1′″, including mouthpiece 2′″. The mouthpiece 2′″ is substantially the same as mouthpiece 2 described above in relation to FIGS. 1 and 2. A difference is that that the mouthpiece 2′″ further comprises a tubular element 20 within the body of material 6.

In the present example the tubular portion 4a and body of material 6 are combined using the second plug wrap 9 which is wrapped around both sections.

The body of material 6 of the article 1′″ of FIG. 5 is similar to the body of material 6 described above in relation to FIGS. 1 to 3. As before, the body of material 6 is manufactured from a sheet material comprising cellulose, for example, the sheet material may be paper. The sheet material is gathered to form the body of material 6. The body of material 6 has an outer volume of at least 115 mm³.

The tubular element 20 may be, for example, a paper of plastic tube disposed within the body of material 6. The tubular element 20 forms a cavity 21 within the body of material 6. Optionally, the tubular element 20 is located substantially radially centrally within the body of material 6.

In the present example, the cavity 21 extends to the downstream end 2b of the mouthpiece 2′″.

In the present example, the axial length L1 of the body of material 6 is about 10 mm. However, a skilled person will recognise that the body of material 6 may have a different axial length L1. Preferably, the length L1 of the body of material 6 is less than about 15 mm. More preferably, the length L1 of the body of material 6 is less than about 10 mm. In addition, or as an alternative, the length L1 of the body of material 6 is at least about 5 mm. Preferably, the length L1 of the body of material 6 is at least about 6 mm. In some preferred embodiments, the length L1 of the body of material 6 is from about 5 mm to about 15 mm, more preferably from about 6 mm to about 12 mm, even more preferably from about 6 mm to about 12 mm, most preferably about 6 mm, 7 mm, 8 mm, 9 mm or 10 mm.

In some embodiments, the tubular element 20 has an axial length L3 of at least 4 mm and, preferably, a length of about 5 mm.

The cavity 21 has been found to promote cooling of the aerosol. The portion 6B of the body of material 6 that surrounds the tubular element 21 has been found to effectively thermally insulate the user's lips from the heat of the aerosol. For example, in embodiments wherein the body of material 6 is manufactured from a sheet material that is arranged into the body of material, it is thought that the multiple layers of the sheet material of the body of material 6 help to insulate the user's lips from the heat of the aerosol. In some embodiments, there may optionally be gaps, for example, air gaps, between the layers of the sheet material that contribute to the insulating effect.

Also, the body of material 6 may be more readily biodegradable than configurations where instead a cellulose acetate tubular portion 8 is provided at the downstream end 2b of the mouthpiece.

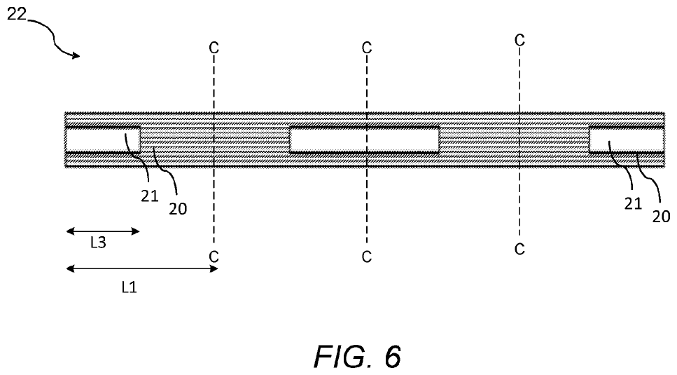

The body of material 6 may be manufactured from a multiple length rod 22, as shown in FIG. 6, which in the present example is a four-length rod. The rod is cut at lines C-C to form individual bodies of material 6 each comprising a tubular element 20 with a corresponding cavity 21.

A non-combustible aerosol provision device is used to heat the aerosol generating material 3 of the articles 1, 1′, 1″, 1′″ described herein. The non-combustible aerosol provision device preferably comprises a coil, since this has been found to enable improved heat transfer to the article 1, 1′, 1′″ as compared to other arrangements.

In some examples, the coil is configured to, in use, cause heating of at least one electrically-conductive heating element, so that heat energy is conductible from the at least one electrically-conductive heating element to the aerosol generating material to thereby cause heating of the aerosol generating material.

In some examples, the coil is configured to generate, in use, a varying magnetic field for penetrating at least one heating element, to thereby cause induction heating and/or magnetic hysteresis heating of the at least one heating element. In such an arrangement, the or each heating element may be termed a “susceptor” as defined herein. A coil that is configured to generate, in use, a varying magnetic field for penetrating at least one electrically-conductive heating element, to thereby cause induction heating of the at least one electrically-conductive heating element, may be termed an “induction coil” or “inductor coil”.

The device may include the heating element(s), for example electrically-conductive heating element(s), and the heating element(s) may be suitably located or locatable relative to the coil to enable such heating of the heating element(s). The heating element(s) may be in a fixed position relative to the coil. Alternatively, the at least one heating element, for example at least one electrically-conductive heating element, may be included in the article 1, 1′, 1″, 1′″ for insertion into a heating zone of the device, wherein the article 1, 1′, 1″, 1′″ also comprises the aerosol generating material 3 and is removable from the heating zone after use. Alternatively, both the device and such an article 1, 1′, 1″, 1′″ may comprise at least one respective heating element, for example at least one electrically-conductive heating element, and the coil may be to cause heating of the heating element(s) of each of the device and the article when the article is in the heating zone.

In some examples, the coil is helical. In some examples, the coil encircles at least a part of a heating zone of the device that is configured to receive aerosol generating material. In some examples, the coil is a helical coil that encircles at least a part of the heating zone.

In some examples, the device comprises an electrically-conductive heating element that at least partially surrounds the heating zone, and the coil is a helical coil that encircles at least a part of the electrically-conductive heating element. In some examples, the electrically-conductive heating element is tubular. In some examples, the coil is an inductor coil.

In some examples, the use of a coil enables the non-combustible aerosol provision device to reach operational temperature more quickly than a non-coil aerosol provision device. For instance, the non-combustible aerosol provision device including a coil as described above can reach an operational temperature such that a first puff can be provided in less than 30 seconds from initiation of a device heating program, more preferably in less than 25 seconds. In some examples, the device can reach an operational temperature in about 20 seconds from the initiation of a device heating program.

The use of a coil as described herein in the device to cause heating of the aerosol generating material has been found to enhance the aerosol which is produced. For instance, consumers have reported that the aerosol generated by a device including a coil such as that described herein is sensorially closer to that generated in factory made cigarette (FMC) products than the aerosol produced by other non-combustible aerosol provision systems. Without wishing to be bound by theory, it is hypothesised that this is the result of the reduced time to reach the required heating temperature when the coil is used, the higher heating temperatures achievable when the coil is used and/or the fact that the coil enables such systems to simultaneously heat a relatively large volume of aerosol generating material, resulting in aerosol temperatures resembling FMC aerosol temperatures. In FMC products, the burning coal generates a hot aerosol which heats tobacco in the tobacco rod behind the coal, as the aerosol is drawn through the rod. This hot aerosol is understood to release flavour compounds from tobacco in the rod behind the burning coal. A device including a coil as described herein is thought to also be capable of heating aerosol generating material, such as tobacco material described herein, to release flavour compounds, resulting in an aerosol which has been reported to more closely resemble an FMC aerosol. Particular improvements in aerosol can be achieved through the use of a device including a coil to heat an article comprising a rod of aerosol generating material having a circumference greater than 19 mm, for instance a circumference between about 19 mm and about 23 mm.

Using an aerosol provision system including a coil as described herein, for instance an induction coil which heats at least some of the aerosol generating material to at least 200° C., more preferably at least 220° C., can enable the generation of an aerosol from an aerosol generating material that has particular characteristics which are thought to more closely resemble those of an FMC product. For example, when heating an aerosol generating material, including nicotine, using an induction heater, heated to at least 250° C., for a two-second period, under an airflow of at least 1.50 L/m during the period, one or more of the following characteristics has been observed:
at least 10 μg of nicotine is aerosolised from the aerosol generating material;
the weight ratio in the generated aerosol, of aerosol-former material to nicotine is at least about 2.5:1, suitably at least 8.5:1;
at least 100 μg of the aerosol-former material can be aerosolised from the aerosol generating material;
the mean particle or droplet size in the generated aerosol is less than about 1000 nm; and
the aerosol density is at least 0.1 μg/cc.

In some cases, at least 10 μg of nicotine, suitably at least 30 μg or 40 μg of nicotine, is aerosolised from the aerosol generating material under an airflow of at least 1.50 L/m during the period. In some cases, less than about 200 μg, suitably less than about 150 μg or less than about 125 μg, of nicotine is aerosolised from the aerosol generating material under an airflow of at least 1.50 L/m during the period.

In some cases, the aerosol contains at least 100 μg of the aerosol-former material, suitably at least 200 μg, 500 μg or 1 mg of aerosol-former material is aerosolised from the aerosol generating material under an airflow of at least 1.50 L/m during the period. Suitably, the aerosol-former material may comprise or consist of glycerol.

As defined herein, the term “mean particle or droplet size” refers to the mean size of the solid or liquid components of an aerosol (i.e. the components suspended in a gas). Where the aerosol contains suspended liquid droplets and suspended solid particles, the term refers to the mean size of all components together.

In some cases, the mean particle or droplet size in the generated aerosol may be less than about 900 nm, 800 nm, 700, nm 600 nm, 500 nm, 450 nm or 400 nm. In some cases, the mean particle or droplet size may be more than about 25 nm, 50 nm or 100 nm.

In some cases, the aerosol density generated during the period is at least 0.1 μg/cc. In some cases, the aerosol density is at least 0.2 μg/cc, 0.3 μg/cc or 0.4 μg/cc. In some cases, the aerosol density is less than about 2.5 μg/cc, 2.0 μg/cc, 1.5 μg/cc or 1.0 μg/cc.

The non-combustible aerosol provision device is preferably arranged to heat the aerosol generating material 3 of the article 1, 1′, 1″, 1′″, to a maximum temperature of at least 160° C. Preferably, the non-combustible aerosol provision device is arranged to heat the aerosol-former material 3 of the article 1, 1′, 1″, 1′″, to a maximum temperature of at least about 200° C., or at least about 220° C., or at least about 240° C., more preferably at least about 270° C., at least once during the heating process followed by the non-combustible aerosol provision device.

Using an aerosol provision system including a coil as described herein, for instance an induction coil which heats at least some of the aerosol generating material to at least 200° C., more preferably at least 220° C.

In some embodiments, the temperature of the aerosol leaving the mouth end of the mouthpiece 2, 2′, 2″, 2′″ is less than 50 degrees Celsius and, preferably, is less than 45 degrees Celsius.

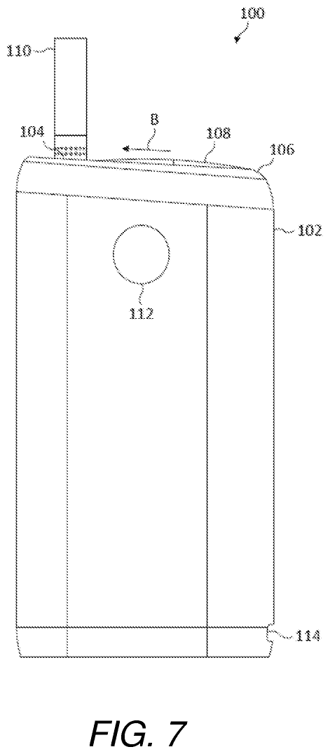

FIG. 7 shows an example of a non-combustible aerosol provision device 100 for generating aerosol from an aerosol generating medium/material such as the aerosol generating material 3 of the articles 1, 1′, 1″, 1′″ described herein. In broad outline, the device 100 may be used to heat a replaceable article 110 comprising the aerosol generating medium, for instance the articles 1, 1′, 1″, 1′″ described herein, to generate an aerosol or other inhalable medium which is inhaled by a user of the device 100. The device 100 and replaceable article 110 together form a system.

The device 100 comprises a housing 102 (in the form of an outer cover) which surrounds and houses various components of the device 100. The device 100 has an opening 104 in one end, through which the article 110 may be inserted for heating by a heating assembly. In use, the article 110 may be fully or partially inserted into the heating assembly where it may be heated by one or more components of the heater assembly.

When the article 110 is inserted into the device 100, the minimum distance between the one or more components of the heater assembly and a tubular body 4a of the article 110 may be in the range 3 mm to 10 mm, for example 3 mm, 4 mm, 5 mm, 6 mm, 7 mm, 8 mm, 9 mm or 10 mm.

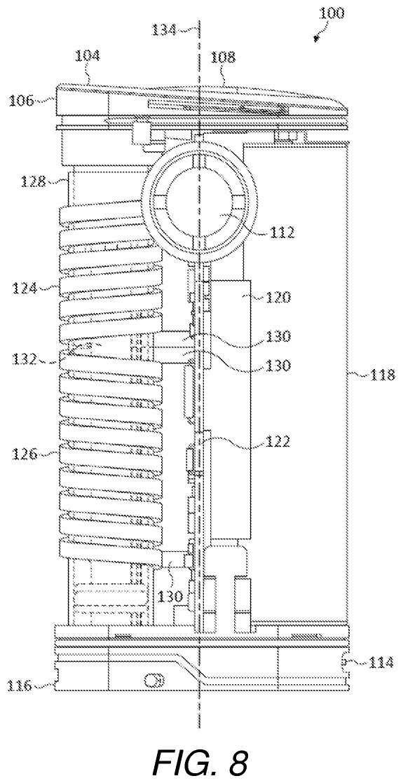

The device 100 of this example comprises a first end member 106 which comprises a lid 108 which is moveable relative to the first end member 106 to close the opening 104 when no article 110 is in place. In FIG. 8, the lid 108 is shown in an open configuration, however the lid 108 may move into a closed configuration. For example, a user may cause the lid 108 to slide in the direction of arrow “B”.

The device 100 may also include a user-operable control element 112, such as a button or switch, which operates the device 100 when pressed. For example, a user may turn on the device 100 by operating the switch 112.

The device 100 may also comprise an electrical component, such as a socket/port 114, which can receive a cable to charge a battery of the device 100. For example, the socket 114 may be a charging port, such as a USB charging port.

FIG. 8 depicts the device 100 of FIG. 7 with the outer cover 102 removed and without an article 110 present. The device 100 defines a longitudinal axis 134.

As shown in FIG. 8, the first end member 106 is arranged at one end of the device 100 and a second end member 116 is arranged at an opposite end of the device 100. The first and second end members 106, 116 together at least partially define end surfaces of the device 100. For example, the bottom surface of the second end member 116 at least partially defines a bottom surface of the device 100. Edges of the outer cover 102 may also define a portion of the end surfaces. In this example, the lid 108 also defines a portion of a top surface of the device 100.

The end of the device closest to the opening 104 may be known as the proximal end (or mouth end) of the device 100 because, in use, it is closest to the mouth of the user. In use, a user inserts an article 110 into the opening 104, operates the user control 112 to begin heating the aerosol generating material and draws on the aerosol generated in the device. This causes the aerosol to flow through the device 100 along a flow path towards the proximal end of the device 100.

The other end of the device furthest away from the opening 104 may be known as the distal end of the device 100 because, in use, it is the end furthest away from the mouth of the user. As a user draws on the aerosol generated in the device, the aerosol flows away from the distal end of the device 100.

The device 100 further comprises a power source 118. The power source 118 may be, for example, a battery, such as a rechargeable battery or a non-rechargeable battery. Examples of suitable batteries include, for example, a lithium battery (such as a lithium-ion battery), a nickel battery (such as a nickel-cadmium battery), and an alkaline battery. The battery is electrically coupled to the heating assembly to supply electrical power when required and under control of a controller (not shown) to heat the aerosol generating material. In this example, the battery is connected to a central support 120 which holds the battery 118 in place.

The device further comprises at least one electronics module 122. The electronics module 122 may comprise, for example, a printed circuit board (PCB). The PCB 122 may support at least one controller, such as a processor, and memory. The PCB 122 may also comprise one or more electrical tracks to electrically connect together various electronic components of the device 100. For example, the battery terminals may be electrically connected to the PCB 122 so that power can be distributed throughout the device 100. The socket 114 may also be electrically coupled to the battery via the electrical tracks.

In the example device 100, the heating assembly is an inductive heating assembly and comprises various components to heat the aerosol generating material of the article 110 via an inductive heating process. Induction heating is a process of heating an electrically conducting object (such as a susceptor) by electromagnetic induction. An induction heating assembly may comprise an inductive element, for example, one or more inductor coils, and a device for passing a varying electric current, such as an alternating electric current, through the inductive element. The varying electric current in the inductive element produces a varying magnetic field. The varying magnetic field penetrates a susceptor suitably positioned with respect to the inductive element, and generates eddy currents inside the susceptor. The susceptor has electrical resistance to the eddy currents, and hence the flow of the eddy currents against this resistance causes the susceptor to be heated by Joule heating. In cases where the susceptor comprises ferromagnetic material such as iron, nickel or cobalt, heat may also be generated by magnetic hysteresis losses in the susceptor, i.e. by the varying orientation of magnetic dipoles in the magnetic material as a result of their alignment with the varying magnetic field. In inductive heating, as compared to heating by conduction for example, heat is generated inside the susceptor, allowing for rapid heating. Further, there need not be any physical contact between the inductive heater and the susceptor, allowing for enhanced freedom in construction and application.

The induction heating assembly of the example device 100 comprises a susceptor arrangement 132 (herein referred to as “a susceptor”), a first inductor coil 124 and a second inductor coil 126. The first and second inductor coils 124, 126 are made from an electrically conducting material. In this example, the first and second inductor coils 124, 126 are made from Litz wire/cable which is wound in a helical fashion to provide helical inductor coils 124, 126. Litz wire comprises a plurality of individual wires which are individually insulated and are twisted together to form a single wire. Litz wires are designed to reduce the skin effect losses in a conductor. In the example device 100, the first and second inductor coils 124, 126 are made from copper Litz wire which has a rectangular cross section. In other examples the Litz wire can have other shape cross sections, such as circular.

The first inductor coil 124 is configured to generate a first varying magnetic field for heating a first section of the susceptor 132 and the second inductor coil 126 is configured to generate a second varying magnetic field for heating a second section of the susceptor 132. In this example, the first inductor coil 124 is adjacent to the second inductor coil 126 in a direction along the longitudinal axis 134 of the device 100 (that is, the first and second inductor coils 124, 126 to not overlap). The susceptor arrangement 132 may comprise a single susceptor, or two or more separate susceptors. Ends 130 of the first and second inductor coils 124, 126 can be connected to the PCB 122.

It will be appreciated that the first and second inductor coils 124, 126, in some examples, may have at least one characteristic different from each other. For example, the first inductor coil 124 may have at least one characteristic different from the second inductor coil 126. More specifically, in one example, the first inductor coil 124 may have a different value of inductance than the second inductor coil 126. In FIG. 8, the first and second inductor coils 124, 126 are of different lengths such that the first inductor coil 124 is wound over a smaller section of the susceptor 132 than the second inductor coil 126. Thus, the first inductor coil 124 may comprise a different number of turns than the second inductor coil 126 (assuming that the spacing between individual turns is substantially the same). In yet another example, the first inductor coil 124 may be made from a different material to the second inductor coil 126. In some examples, the first and second inductor coils 124, 126 may be substantially identical.

In this example, the first inductor coil 124 and the second inductor coil 126 are wound in opposite directions. This can be useful when the inductor coils are active at different times. For example, initially, the first inductor coil 124 may be operating to heat a first section/portion of the article 110, and at a later time, the second inductor coil 126 may be operating to heat a second section/portion of the article 110. Winding the coils in opposite directions helps reduce the current induced in the inactive coil when used in conjunction with a particular type of control circuit. In FIG. 8, the first inductor coil 124 is a right-hand helix and the second inductor coil 126 is a left-hand helix. However, in another embodiment, the inductor coils 124, 126 may be wound in the same direction, or the first inductor coil 124 may be a left-hand helix and the second inductor coil 126 may be a right-hand helix.

The susceptor 132 of this example is hollow and therefore defines a receptacle within which aerosol generating material is received. For example, the article 110 can be inserted into the susceptor 132. In this example the susceptor 120 is tubular, with a circular cross section.

The susceptor 132 may be made from one or more materials. Preferably the susceptor 132 comprises carbon steel having a coating of Nickel or Cobalt.

In some examples, the susceptor 132 may comprise at least two materials capable of being heated at two different frequencies for selective aerosolization of the at least two materials. For example, a first section of the susceptor 132 (which is heated by the first inductor coil 124) may comprise a first material, and a second section of the susceptor 132 which is heated by the second inductor coil 126 may comprise a second, different material. In another example, the first section may comprise first and second materials, where the first and second materials can be heated differently based upon operation of the first inductor coil 124. The first and second materials may be adjacent along an axis defined by the susceptor 132, or may form different layers within the susceptor 132. Similarly, the second section may comprise third and fourth materials, where the third and fourth materials can be heated differently based upon operation of the second inductor coil 126. The third and fourth materials may be adjacent along an axis defined by the susceptor 132, or may form different layers within the susceptor 132. Third material may the same as the first material, and the fourth material may be the same as the second material, for example. Alternatively, each of the materials may be different. The susceptor may comprise carbon steel or aluminium for example.

The device 100 of FIG. 8 further comprises an insulating member 128 which may be generally tubular and at least partially surround the susceptor 132. The insulating member 128 may be constructed from any insulating material, such as plastic for example. In this particular example, the insulating member is constructed from polyether ether ketone (PEEK). The insulating member 128 may help insulate the various components of the device 100 from the heat generated in the susceptor 132.

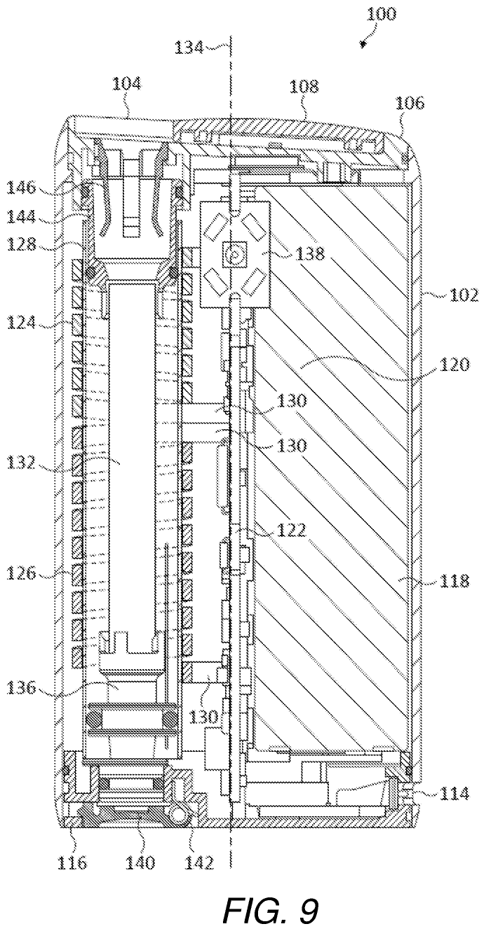

The insulating member 128 can also fully or partially support the first and second inductor coils 124, 126. For example, as shown in FIG. 9, the first and second inductor coils 124, 126 are positioned around the insulating member 128 and are in contact with a radially outward surface of the insulating member 128. In some examples the insulating member 128 does not abut the first and second inductor coils 124, 126. For example, a small gap may be present between the outer surface of the insulating member 128 and the inner surface of the first and second inductor coils 124, 126.

In a specific example, the susceptor 132, the insulating member 128, and the first and second inductor coils 124, 126 are coaxial around a central longitudinal axis of the susceptor 132.

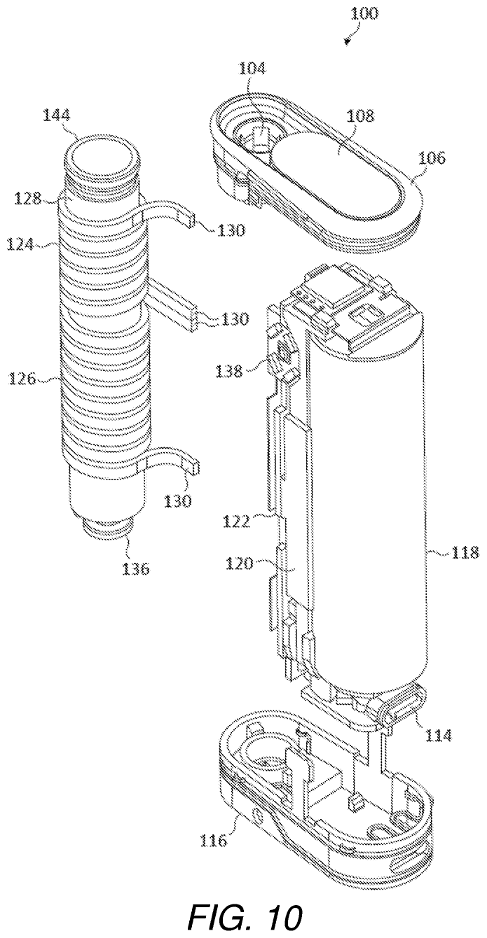

FIG. 10 shows a side view of device 100 in partial cross-section. The outer cover 102 is present in this example. The rectangular cross-sectional shape of the first and second inductor coils 124, 126 is more clearly visible.

The device 100 further comprises a support 136 which engages one end of the susceptor 132 to hold the susceptor 132 in place. The support 136 is connected to the second end member 116.

The device may also comprise a second printed circuit board 138 associated within the control element 112.

The device 100 further comprises a second lid/cap 140 and a spring 142, arranged towards the distal end of the device 100. The spring 142 allows the second lid 140 to be opened, to provide access to the susceptor 132. A user may open the second lid 140 to clean the susceptor 132 and/or the support 136.

The device 100 further comprises an expansion chamber 144 which extends away from a proximal end of the susceptor 132 towards the opening 104 of the device. Located at least partially within the expansion chamber 144 is a retention clip 146 to abut and hold the article 110 when received within the device 100. The expansion chamber 144 is connected to the end member 106.

FIG. 10 is an exploded view of the device 100 of FIG. 9, with the outer cover 102 omitted.

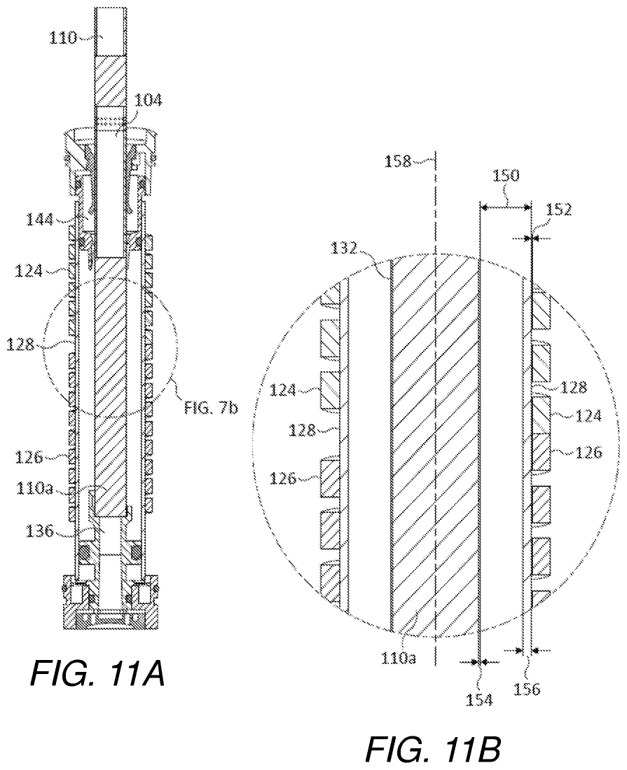

FIG. 11A depicts a cross section of a portion of the device 100 of FIG. 9. FIG. 11B depicts a close-up of a region of FIG. 11A. FIGS. 11A and 11B show the article 110 received within the susceptor 132, where the article 110 is dimensioned so that the outer surface of the article 110 abuts the inner surface of the susceptor 132. This ensures that the heating is most efficient. The article 110 of this example comprises aerosol generating material 110a. The aerosol generating material 110a is positioned within the susceptor 132. The article 110 may also comprise other components such as a filter, wrapping materials and/or a cooling structure.

FIG. 11B shows that the outer surface of the susceptor 132 is spaced apart from the inner surface of the inductor coils 124, 126 by a distance 150, measured in a direction perpendicular to a longitudinal axis 158 of the susceptor 132. In one particular example, the distance 150 is about 3 mm to 4 mm, about 3-3.5 mm, or about 3.25 mm.

FIG. 11B further shows that the outer surface of the insulating member 128 is spaced apart from the inner surface of the inductor coils 124, 126 by a distance 152, measured in a direction perpendicular to a longitudinal axis 158 of the susceptor 132. In one particular example, the distance 152 is about 0.05 mm. In another example, the distance 152 is substantially 0 mm, such that the inductor coils 124, 126 abut and touch the insulating member 128.

In one example, the susceptor 132 has a wall thickness 154 of about 0.025 mm to 1 mm, or about 0.05 mm.

In one example, the susceptor 132 has a length of about 40 mm to 60 mm, about 40 mm to 45 mm, or about 44.5 mm.

In one example, the insulating member 128 has a wall thickness 156 of about 0.25 mm to 2 mm, 0.25 mm to 1 mm, or about 0.5 mm.

In use, the articles 1, 1′, 1″, 1′″ described herein can be inserted into a non-combustible aerosol provision device such as the device 100 described with reference to FIGS. 7 to 11B. At least a portion of the mouthpiece 2, 2′, 2″, 2′″ of the article 1, 1′, 1″, 1′″ protrudes from the non-combustible aerosol provision device 100 and can be placed into a user's mouth. An aerosol is produced by heating the aerosol generating material 3 using the device 100. The aerosol produced by the aerosol generating material 3 passes through the mouthpiece 2 to the user's mouth.

The articles 1, 1′, 1″, 1′″ described herein have particular advantages, for instance when used with non-combustible aerosol provision devices such as the device 100 described with reference to FIGS. 7 to 11B. In particular, the first tubular element 4a has surprisingly been found to have a significant influence on the temperature of the outer surface of the mouthpiece 2, 2′, 2″, 2′″ of the article 1, 1′, 1″, 1′″. As mentioned previously, the thickness and porosity and wrapper helps to reduce temperature.

The hollow tubular element of the mouthpiece 2′ has also been found to have a significant influence on the temperature of the outer surface of the mouthpiece 2′ of the article 1′. For instance, where the hollow tubular element 8 formed from filamentary tow is wrapped in an outer wrapper, for instance the tipping paper 5, an outer surface of the outer wrapper at a longitudinal position corresponding to the location of the hollow tubular element 8 has been found to reach a maximum temperature of less than 42° C. during use, suitably less than 40° C. and more suitably less than 38° C. or less than 36° C.

Table 1.0 below shows the temperature of the outer surface of the article 1′ as described with reference to FIG. 3 herein when heated using the device 100 described with reference to FIGS. 7 to 11B herein. In this example, the axial length of the hollow tubular element 8 is 6 mm, the length of the body of material 6 is 10 mm, and the length of the tubular portion 4a is 25 mm. There is a pressure drop of 4.38 mmWG across the body of material 6 of the article 1′.

First, second and third temperature measuring probes were used as corresponding first, second and third positions along the mouthpiece 2′ of the article 1′. The first position (numbered as position 1 in table 1.0) was at 4 mm from the downstream end 2b of the mouthpiece 2′, the second position (numbered as position 2 in table 1.0) was at 8 mm from the downstream end 2b of the mouthpiece 2′, and the third position (numbered as position 3 in table 1.0) was at 12 mm from the downstream end 2b of the mouthpiece 2′.

The first position was therefore on the outer surface of the part of the mouthpiece 2′ in which the hollow tubular element 8 is disposed, while the second and third positions were on the outer surface of the part of the mouthpiece 2′ in which the body of material 6 is disposed.

Testing was performed for the first 9 puffs on the article, using standard testing equipment at a 60% relative humidity at 22 degrees Celsius environmental conditions.

TABLE 1.0

| Probe | Puff | Puff | Puff | Puff | Puff | Puff | Puff | Puff | Puff |
|---|---|---|---|---|---|---|---|---|---|
| Pos. | 1 | 2 | 3 | 4 | 5 | 6 | 7 | 8 | 9 |
| 1 | 33.6 | 38.2 | 39.1 | 39.6 | 38.6 | 37.4 | 36.5 | 35.4 | 34.4 |
| 2 | 43.9 | 48.6 | 48.4 | 48.6 | 46.6 | 44.9 | 43.7 | 42 | 40.8 |
| 3 | 48.4 | 52.4 | 51.4 | 51.8 | 49.9 | 48.7 | 47.6 | 46.4 | 44.8 |

The above was repeated for an article that has the same features as the article 1′ tested above, but instead having a pressure drop of 8.13 mmWG. The results are shown in Table 2.0 below.

TABLE 2.0

| Probe | Puff | Puff | Puff | Puff | Puff | Puff | Puff | Puff | Puff |
|---|---|---|---|---|---|---|---|---|---|
| Pos. | 1 | 2 | 3 | 4 | 5 | 6 | 7 | 8 | 9 |
| 1 | 30.1 | 34.5 | 36 | 36.8 | 36.1 | 35.2 | 34.5 | 33.6 | 32.8 |
| 2 | 40.1 | 45.1 | 45.9 | 46.2 | 44.2 | 42.4 | 41.4 | 39.7 | 38.6 |
| 3 | 46.4 | 51.4 | 51.2 | 51.5 | 49.4 | 47.6 | 46.3 | 44.7 | 43.2 |

The above was repeated for an article that has the same features as the article 1′ tested above, but instead having a pressure drop of 11.88 mmWG. The results are shown in Table 3.0 below.

TABLE 3.0

| Probe | Puff | Puff | Puff | Puff | Puff | Puff | Puff | Puff | Puff |
|---|---|---|---|---|---|---|---|---|---|
| Pos. | 1 | 2 | 3 | 4 | 5 | 6 | 7 | 8 | 9 |
| 1 | 31.5 | 35.8 | 36.9 | 37.4 | 36.8 | 35.9 | 35.1 | 34.1 | 33.2 |
| 2 | 43.3 | 48.4 | 48.3 | 48.3 | 46.4 | 44.4 | 42.9 | 40.8 | 39.5 |
| 3 | 51 | 54.7 | 53.5 | 53.5 | 51.4 | 49.8 | 48.3 | 46.7 | 45.2 |

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the invention as defined by the claims or limitations on equivalents to the claims, and that other embodiments may be utilised and modifications may be made without departing from the scope of the claimed invention. Various embodiments of the invention may suitably comprise, consist of, or consist essentially of, appropriate combinations of the disclosed elements, components, features, parts, steps, means, etc, other than those specifically described herein. In addition, this disclosure may include other inventions not presently claimed, but which may be claimed in future.

1. An article for use in a non-combustible aerosol provision system, the article comprising:
an aerosol generating material, and
a downstream portion located downstream of the aerosol generating material, wherein the downstream portion comprises a body of material having a volume of at least 115 mm³ and wherein said body of material comprises cellulose.

2. An article for use in aerosol provision system, the article comprising:
an aerosol generating material, and
a downstream portion located downstream of the aerosol generating material, wherein the downstream portion comprises a body of material and a tubular element located within the body of material, the tubular element comprising a cavity.

3. An article according to claim 2, wherein the tubular element is located substantially radially centrally within the body of material.

4. An article according to claim 2 or claim 3, wherein the tubular element extends to a downstream end of the body of material.

5. An article according to any one of claims 2 to 4, wherein the tubular element in manufactured from paper.

6. An article according to any one of claims 2 to 5, wherein the tubular element has a length of at least 4 mm and, preferably, a length of about 5 mm.

7. An article according to any one of claims 2 to 6, wherein the body of material has a volume of at least 115 mm³.

8. An article according to any one of claims 2 to 7, wherein the body of material comprises cellulose.

9. An article for use in aerosol provision system, the article comprising:
an aerosol generating material, and
a downstream portion located downstream of the aerosol generating material, wherein the downstream portion comprises a body of material comprising cellulose, and wherein the downstream portion further comprises at least one aerosol modifying agent release component incorporated within the body of material.

10. An article according to claim 9 wherein the body of material has a volume of at least 115 mm³ and wherein said body of material comprises cellulose.

11. An article according to claim 9 or claim 10, wherein the article further comprises a second aerosol release component incorporated within the body of material.

12. An article according to any one of claims 9 to 11, wherein the or each aerosol modifying agent release component comprises a capsule.

13. An article according to claim 12, wherein the or each capsule comprises a solid shell and a liquid core.

14. An article according to claim 12 or claim 13, wherein the or each capsule has a burst strength in the range 5 to 30 N.

15. An article according to any one of claims 9 to 14, wherein the or each aerosol modifying agent release component has a diameter in the range of 2.8 mm and 4 mm and, preferably, in the range of 2.8 mm and 3.6 mm.

16. An article according to any one of claims 1 to 15, wherein the body of material comprises a sheet of material arranged to form the body.

17. An article according to claim 16, wherein the sheet material has a basis weight of 100 gsm or less and, preferably, 90 gsm or less, 80 gsm or less, 70 gsm or less, 60 gsm or less, 50 gsm or less, or 40 gsm or less, or 30 gsm or less.

18. An article according to claim 16 or claim 17, wherein the sheet material has a basis weight of at least 20 gsm and, preferably, at least 30, 40, 50 or 60 gsm.

19. An article according to any one of claims 16 to 18, wherein the sheet material has a width of at least 60 mm and, preferably, at least 70, 80, 90, 100, 110 or 120 mm.

20. An article according to any one of claims 16 to 19, wherein the sheet material has a width of at most 240 mm and, preferably, at most 230, 220, 210, 200, 190, 180, 170, 160 or 150 mm.

21. An article according to any one of claims 16 to 20, wherein the sheet material is folded to form the body.

22. An article according to any one of claims 16 to 21, wherein the sheet material is crimped.

23. An article according to claim 22, wherein the sheet material is crimped to a crimp depth of at least 0.2 mm and, preferably, at least 0.3 mm, 0.4 mm or 0.5 mm.

24. An article according to claim 22 or claim 23, wherein the sheet material is crimped to a crimp depth of at most 0.8 mm and, preferably, at most 0.6 mm, or 0.5 mm.

25. An article according to any one of claims 1 to 24, wherein the body of material has a volume of least 200 mm³ or at least 300 mm³.

26. An article according to any one of claims 1 to 25, wherein the body of material has a volume of at least 19 mm³ per mm axial length of the body of material and, preferably, at least 25 mm³ per mm axial length or at least 30 mm³ per mm.

27. An article according to any one of claims 1 to 26 wherein the body of material has a weight of at least 2 mg per mm axial length of the body of material and, preferably, at least 3 mg per mm axial length or at least 4 mg per mm axial length.

28. An article according to any one of claims 1 to 27, wherein the body of material is a solid cylindrical body of material.

29. An article according to any one of the preceding claims, wherein the body of material comprises paper.

30. An article according to any one of the preceding claims, wherein the body of material comprises reconstituted tobacco comprising the cellulose.

31. An article according to any one of the preceding claims, wherein the body has a density of at least 0.05 mg/mm³ and, preferably, density of at least 0.07 mg/mm³, or at least 0.1 mg/mm³, and, preferably, at least 0.12 mg/mm³.

32. An article according to any one of the preceding claims, wherein the pressure drop across the body of material is at least 2 mmWG and, preferably, at least 3 mmWG and, preferably, at least 4 mmWG, at least 6 mmWG, at least 8 mmWG, at least 10 mmWG or at least 11 mmWG, or at least 12 mmWG, or at least 15 mmWG.

33. An article according to any one of the preceding claims, wherein the pressure drop across the body of material is less than 25 mmWG and, preferably, less than 23 mmWG, less than 20 mmWG, less than 15 mmWG, less than 14 mmWG and, preferably, less than 12 mmWG.

34. An article according to any one of the preceding claims, wherein the pressure drop across the body of material is at least 1, 1.1, 1.2, 1.5, 2 or 2.33 mmWG per mm axil length of the body of material.

35. An article according to any one of the preceding claims, wherein the pressure drop across the body of material is less than 2.5 mmWG per mm axial length of the body of material and, preferably, is less than 2.3, 2, 1.5, 1.4, 1.2 or 1 mmWG per mm axial length of the body of material.

36. An article according to any one of the preceding claims, wherein the body of material has an axial length of at least 4 mm and, preferably, at least 5 mm and, preferably, at least 6 mm, at least 7 mm, at least 8 mm, at least 9 mm or at least 10 mm.

37. An article according to claim 36, wherein the body of material has an axial length of about 10 mm.

38. An article according to any one of the preceding claims, wherein the body of material has a circumference of at least 16 mm and, preferably, at least 18 mm or at least 20 mm.

39. An article according to any one of the preceding claims, wherein an aerosol-modifying agent is applied to the body of material.

40. An article according to any one of the preceding claims, wherein an aerosol-former material is applied to the body of material.

41. An article according to claim 40, wherein the aerosol-former material comprises one or more of glycerine, glycerol, propylene glycol, diethylene glycol, triethylene glycol, tetraethylene glycol, 1,3-butylene glycol, erythritol, meso-Erythritol, ethyl vanillate, ethyl laurate, a diethyl suberate, triethyl citrate, triacetin, a diacetin mixture, benzyl benzoate, benzyl phenyl acetate, tributyrin, lauryl acetate, lauric acid, myristic acid, and propylene carbonate.

42. An article according to claim 40 or claim 41, wherein at least 0.02 mg of aerosol-former material is applied to the body of material per 1 mm axial length of the body of material and, preferably, at least 0.03, 0.04 or 0.05 mg of aerosol-former material is applied to the body of material per 1 mm axial length of the body of material.

43. An article according to any one of claims 40 to 42, wherein 0.5 mg or less of aerosol-former material is applied to the body of material per 1 mm axial length of the body of material and, preferably, 0.4 mg or less, 0.3 mg or less, 0.2 mg or less, or 0.1 mg or less of aerosol-former material is applied to the body of material per 1 mm axial length of the body of material.

44. An article according to any one of the preceding claims, further comprising a tube and, preferably, the tube is a paper tube.

45. An article according to claim 44, wherein the tube has an axial length of at least 20 mm and, preferably, at least 23 mm.

46. An article according to claim 45, wherein the tube is downstream of the body of material and, optionally, a downstream end of the mouthpiece comprises an end of the tube.

47. An article according to any one of claims 44 to 46, wherein the body of material and tube are adjacent.

48. An article according to any one of claims 44 to 47, wherein the tube comprises one or more ventilation holes.

49. An article according to any one of the preceding claims, comprising a tubular portion downstream of the body of material, and, preferably, the tubular portion comprises paper or cellulose acetate.

50. An article according to claim 1 or any one of claims 9 to 49 when dependent on claim 1, comprising a tubular element located within the body of material, the tubular element comprising a cavity.

51. An article according to claim 50, wherein the tubular element is located substantially radially centrally within the body of material.

52. An article according to claim 50 or claim 51, wherein the tubular element extends to a downstream end of the body of material.

53. An article according to any one of claims 50 to 52, wherein the tubular element in manufactured from paper.

54. An article according to any one of claims 50 to 53, wherein the tubular element has a length of at least 4 mm and, preferably, a length of about 5 mm.

55. An article according to any one of the preceding claims, wherein the body of material circumscribed by a wrapper has a hardness in the range of about 80% to 95% and, preferably, in the range of about 85% to 900%.

56. An article according to any one of the preceding claims, wherein the roundness of the article at the downstream portion is at least 90% and, preferably, is at least 91%, 92%, 93%, 94% or 95%.

57. An article according to any one of the preceding claims, wherein the aerosol generating material comprises a first aerosol generating material, and the article further comprises a component downstream of the first aerosol generating material, wherein the component comprises a tubular portion and wherein the tubular portion comprises a wall comprising a second aerosol generating material.

58. An article according to any one of the preceding claims, wherein the aerosol generating material is wrapped by a wrapper having a level of permeability greater than about 2000 Coresta Units, and wherein the article comprises a downstream portion downstream of the aerosol generating material, comprising at least one ventilation area.

59. An article according to any one of the preceding claims, wherein the article is configured such that when the article is inserted into a non-combustible aerosol provision device, the minimum distance between a heater of the non-combustible aerosol provision device and a tubular section of the article is at least about 3 mm.

60. An article according to any one of the preceding claims, wherein the level of ventilation provided by said one or more ventilation holes is within the range of 45% to 65% of the volume of aerosol passing through the component, or between 40% and 60% of the volume of aerosol passing through the component.

61. An article according to any one of the preceding claims, comprising a hollow tubular element extending from a mouth end of the article, wherein the hollow tubular element comprises a length of greater than about 10 mm or greater than about 12 mm.

62. An article according to any one of claims 1 to 8, or any one of claims 16 to 61 when dependent on any one of claims 1 to 8, comprising at least one aerosol modifying agent release component incorporated within the body of material.

63. An article according to claim 62, wherein the aerosol modifying agent release component comprises a capsule.

64. An article according to claim 63, wherein the capsule comprises a solid shell and a liquid core.

65. An article according to claim 63 or claim 64, wherein the or each capsule has a burst strength in the range 5 to 30 N.

66. An article according to any one of claims 62 to 65, wherein the aerosol modifying agent release component has a diameter in the range of 2.8 mm and 4 mm and, preferably, in the range of 2.8 mm and 3.6 mm.

67. An article according to any one of the preceding claims, wherein the article is an article for a non-combustible aerosol provision system.

68. An article according to any one of the preceding claims, wherein the article is an article for a combustible aerosol provision system.

69. An aerosol provision system comprising an article according to any one of the preceding claims.

70. An aerosol provision system according to claim 69, wherein the aerosol provision system is a non-combustible aerosol provision system.

71. An aerosol provision system according to claim 70, wherein the non-combustible aerosol provision system is an aerosol generating material heating system and, preferably is a tobacco heating system.
